(19) United States
(12) Patent Application Publication
(10) Pub. No.: US 2013/0326341 A1
(43) Pub. Date: Dec. 5, 2013

(54) DIGITAL COMIC EDITOR, METHOD AND NON-TRANSITORYCOMPUTER-READABLE MEDIUM

(71) Applicant: FUJIFILM Corporation, Tokyo (JP)

(72) Inventor: Shunichiro NONAKA, Tokyo (JP)

(73) Assignee: FUJIFILM Corporation, Tokyo (JP)

(21) Appl. No.: 13/960,631

(22) Filed: Aug. 6, 2013

Related U.S. Application Data
(63) Continuation of application No. PCT/JP2012/077180, filed on Oct. 22, 2012.

(30) Foreign Application Priority Data
Oct. 21, 2011 (JP) 2011-232155

(51) Int. Cl. G06F 17/24; G06K 9/46

(52) U.S. Cl. CPC G06F 17/24; G06K 9/46
USPC 715/246

(57) ABSTRACT

A digital comic editor causes a display unit to display an image thereon based on an image file, and to superimposingly display an image indicating each piece of region information included in two or more pieces of information on the image based on the two or more pieces of information included in an information file; adds association information for associating a plurality of pieces of region information corresponding to a position indicated by indication unit; deletes the association of the plurality of pieces of region information corresponding to the position indicated by the indication unit; and updates the information file based on the association information added or deleted.

### CROSS-REFERENCE TO RELATED APPLICATIONS

This application is a continuation application and claims the priority benefit under 35 U.S.C. §120 of PCT Application No. PCT/JP2012/077180 filed on Oct. 22, 2012 which application designates the U.S., and also claims the priority benefit under 35 U.S.C. §119 of Japanese Patent Application No. 2011-232155 filed on Oct. 21, 2011, which applications are all hereby incorporated by reference in their entireties.

### BACKGROUND OF THE INVENTION

1. Field of the Invention

The present invention relates to a digital comic editor and a method, particularly relates to an art to digitize comic contents.

2. Description of the Related Art

In recent years, portable communication teiniinals having a function of browsing web sites via a communication network have become widespread. As a content to be browsed from a portable communication terminal, there is known a digital comic digitized by, for example, scanning a comic (cartoon) published in a magazine or the like with a scanner.

As for digital comics, there are proposed various techniques for generating data so as to be appropriately displayed on a display unit of a portable communication terminal, during the digitization of comics.

For example, Japanese Patent Application Laid-Open No. 2010-129068 (hereinafter referred to as Patent Literature 1) discloses an image editing device including: original image group storing means for storing an original image group having a story line that is developed frame-by-frame in a system that transmits the image group having a story line that is developed frame-by-frame, such as a cartoon, from a server to a portable communication terminal; frame arrangement setting means for setting an arrangement of each frame of the image group stored in the storing means; photocomposition setting means for setting the photocomposition of each frame of the image group set by the frame arrangement setting means; frame arrangement information storage means for storing frame arrangement information set by the frame arrangement setting means; and photocomposition information storage means for storing photocomposition information set by the photocomposition setting means.

According to Patent Literature 1, in addition to information about the frame arrangement, photocomposition information of each frame is stored in parallel as a process for the image group whose story line is to be developed frame-by-frame. Also in the case of providing a user with images for browsing, the photocomposition information corresponding to each frame enables clear display, display in other languages, or editing by a browsing user, for example, which increases the pleasure of browsing the image group. For example, with regard to a problem that a dialogue part is too small to see, the photocomposition information or the like enables a dialogue part to be reliably browsed.

However, Patent Literature 1 does not disclose how to process the photocomposition existing between a plurality of frames in the case of obtaining the photocomposition information of each frame. Accordingly, it is unclear how to correct the association between the photocomposition and each frame, when the association is inappropriate.

Furthermore, the constituent elements of comics include not only photocomposition information (text) disposed within each frame, but also a character serving as a region of interest, a speech bubble indicating a dialog of a character, and the like. Patent Literature 1 has a problem that these pieces of information cannot be effectively used.

### SUMMARY OF THE INVENTION

The present invention has been proposed in view of the above circumstances, and an object of the present invention is to provide a digital comic editor and a method capable of, when digitizing a comic content, easily editing association results obtained by associating frame information, a speech bubble, text, a region of interest, and the like.

To achieve the above object, a digital comic editor according to an aspect of the invention includes: a data acquisition unit that acquires master data of a digital comic including an image file corresponding to each page of the comic, the image file having a high resolution image of the entire page; and an information file corresponding to each page or all pages of the comic, the information file having described therein two or more pieces of information from among: frame information including frame region information of each frame within the page; speech bubble information including speech bubble region information indicating a region within the image of a speech bubble including a line of a character of the comic; text region information indicating a text region of the comic; and region of interest information indicating a region of interest of the comic, and association information for associating the two or more pieces of information; a display control unit that causes a display unit to display an image thereon based on the image file in the master data acquired by the data acquisition unit, to superimposingly display an image indicating each piece of region information included in the two or more pieces of information on the image based on the two or more pieces of information included in the information file in the master data, and to superimposingly display an image indicating that the two or more pieces of information are associated with each other on the image based on the association information; an indication unit that indicates a position on the image displayed on the display unit; an association information addition unit that adds association information for associating a plurality of pieces of region information corresponding to the position indicated by the indication unit; an association information deletion unit that deletes the association of the plurality of pieces of region information corresponding to the position indicated by the indication unit; and an editing unit that updates the association information included in the information file based on the association information added by the association information addition unit and the association information deleted by the association information deletion unit.

According to the aspect of the invention, the association information for associating the plurality of pieces of region information corresponding to the position indicated by the indication unit is added; the association of the plurality of pieces of region information corresponding to the position indicated by the indication unit is deleted; and the association information included in the information file is updated based on the association information added or deleted. Accordingly, when digitizing a comic content, it is possible to easily edit association results obtained by associating frame information, a speech bubble, text, a region of interest, and the like.

The display control unit preferably superimposingly displays an image obtained by depicting an outer peripheral edge of each of the regions corresponding to the two or more pieces of information associated with each other based on the association information, by using the same color or line type, on the image. This enables a user to appropriately recognize the associated regions.

Further, the display control unit may superimposingly display an image obtained by depicting a lead line connecting the regions corresponding to the two or more pieces of information associated with each other on the image based on the association information. Even when the image is displayed in this manner, the associated regions can be appropriately recognized by a user.

The region of interest information is region information including a character within the comic. The association information is preferably information for associating region of interest information including the character, speech bubble region information indicating a speech bubble region including a line of the character, or text region information indicating a text region within the speech bubble region. The association of these pieces of information enables generation of appropriate master data.

The association information may be information for associating the frame information, the speech bubble information, the text region information, and the region of interest information. The association of these pieces of information enables generation of appropriate master data.

The frame region information of each frame is preferably coordinate data representing each vertex on a polygonal frame boundary enclosing each frame, vector data representing the frame boundary, or mask data representing a frame region of each frame. This makes it possible to obtain appropriate frame region information.

The speech bubble region information is preferably coordinate data representing a plurality of points corresponding to a shape of the speech bubble, vector data representing the shape of the speech bubble, or mask data representing a region of the speech bubble. This makes it possible to obtain appropriate speech bubble region information.

The text region information is preferably coordinate data representing each vertex on a polygonal outer peripheral edge of the text region, vector data representing the outer peripheral edge of the text region, or mask data representing the text region. This makes it possible to obtain appropriate text region information.

The region of interest information is preferably coordinate data representing each vertex on a polygonal outer peripheral edge of the region of interest, vector data representing the outer peripheral edge of the region of interest, or mask data representing the region. This makes it possible to obtain appropriate frame region of interest information.

The digital comic editor preferably includes: an image acquisition unit that acquires an image file having a high resolution image of the entire page; a region extraction unit that analyzes the image of the entire page acquired by the image acquisition unit and automatically extracts two or more regions from among a frame region of each frame within the page, a speech bubble region, a text region, and a region of interest; an information file creation unit that creates the information file having described therein information indicating the two or more regions extracted by the region extraction unit, and association information of the two or more regions; and a master data creation unit that creates the master data of the digital comic including the image file of each page of the comic acquired by the image acquisition unit and the information file corresponding to each page or all pages of the comic created by the information file creation unit. The data acquisition unit preferably acquires the master data created by the master data creation unit. The information file is automatically generated in this manner, thereby enabling digitization of comics within a short period of time.

To achieve the above object, a digital comic editing method according to an aspect of the invention includes: a data acquisition step acquiring master data of a digital comic including an image file corresponding to each page of the comic, the image file having a high resolution image of the entire page; and an information file corresponding to each page or all pages of the comic, the information file having described therein two or more pieces of information from among: frame information including frame region information of each frame within the page; speech bubble information including speech bubble region information indicating a region within the image of a speech bubble including a line of a character of the comic; text region information indicating a text region of the comic; and region of interest information indicating a region of interest of the comic, and association information for associating the two or more pieces of information; a display control step causing a display unit to display an image thereon based on the image file in the master data acquired by the data acquisition step, to superimposingly display an image indicating each piece of region information included in the two or more pieces of information on the image based on the two or more pieces of information included in the information file in the master data, and to superimposingly display an image indicating that the two or more pieces of information are associated with each other on the image based on the association information; an indication step indicating a position on the image displayed on the display unit; an association information addition step adding association information for associating a plurality of pieces of region information corresponding to the position indicated by the indication step; an association information deletion step deleting the association of the plurality of pieces of region information corresponding to the position indicated by the indication step; and an editing step updating the association information included in the information file based on the association information added by the association information addition step and the association information deleted by the association information deletion step.

To achieve the above object, a non-transitory computer-readable medium storing a digital comic editing program according to an aspect of the present invention causes a computer to achieve: a data acquisition function to acquire master data of a digital comic including an image file corresponding to each page of the comic, the image file having a high resolution image of the entire page; and an information file corresponding to each page or all pages of the comic, the information file having described therein two or more pieces of information from among: frame information including frame region information of each frame within the page; speech bubble information including speech bubble region information indicating a region within the image of a speech bubble including a line of a character of the comic; text region information indicating a text region of the comic; and region of interest information indicating a region of interest of the comic, and association information for associating the two or more pieces of information; a display control function to cause a display unit to display an image thereon based on the image file in the master data acquired by the data acquisition function, to superimposingly display an image indicating each piece of region information included in the two or more pieces of information on the image based on the two or more pieces of information included in the information file in the master data, and to superimposingly display an image indicating that the two or more pieces of information are associated with each other on the image based on the association information; an indication function to indicate a position on the image displayed on the display unit; an association information addition function to add association information for associating a plurality of pieces of region information corresponding to the position indicated by the indication function; an association information deletion function to delete the association of the plurality of pieces of region information corresponding to the position indicated by the indication function; and an editing function to update the association information included in the information file based on the association information added by the association information addition function and the association information deleted by the association information deletion function.

According to the present invention, when digitizing a comic content, it is possible to easily edit association results obtained by associating frame information, a speech bubble, text, a region of interest, and the like.

### BRIEF DESCRIPTION OF THE DRAWINGS

FIG. 1 illustrates a configuration of a content delivery system according to the invention.

FIG. 2 is a flow chart of master data creation.

FIG. 3 illustrates an example of a content image.

FIG. 4 illustrates an example of a monitor display.

FIG. 5 illustrates a result of frames which are automatically detected from a content image.

FIG. 6 illustrates a modification result of the frame detection result shown in FIG. 5.

FIG. 7 illustrates a result of frames which are automatically detected from the content image.

FIG. 8 illustrates a modification result of the frame detection result shown in FIG. 7.

FIG. 9 illustrates a modification of a frame boundary line.

FIG. 10 illustrates a result of speech bubbles which are automatically extracted from the content image.

FIG. 11 illustrates a modification of the speech bubble extraction result shown in FIG. 10.

FIG. 12 illustrates a result of the speech bubbles which are automatically extracted from the content image.

FIG. 13 illustrates a modification of the speech bubble extraction result shown in FIG. 12.

FIG. 14 illustrates a result of speech bubbles which are automatically extracted from the content image.

FIG. 15 illustrates an extraction of a speech bubble.

FIG. 16 illustrates an extraction of the speech bubble.

FIG. 17 illustrates an extraction of the speech bubble.

FIG. 18 illustrates an extraction of the speech bubble.

FIG. 19 illustrates an extraction of the speech bubble.

FIG. 20 illustrates a result of texts which are automatically extracted from the content image.

FIG. 21 illustrates a modification of the text extraction result shown in FIG. 20.

FIG. 22 illustrates a result of regions of interest which are automatically extracted from the content image.

FIG. 23 illustrates a modification of the region of an interest extraction result shown in FIG. 20.

FIG. 24 illustrates association of the speech bubbles and the regions of interest.

FIG. 25 illustrates association of the speech bubbles and the regions of interest.

FIG. 26 is a frame format of a structure of an information file.

FIG. 27 is an example of a monitor screen when editing master data.

FIG. 28 is an example of the monitor screen when editing master data.

FIG. 29 is an example of the monitor screen when editing master data.

FIG. 30 is an example of a preview screen.

FIG. 31 is a block diagram illustrating an internal configuration of an authoring section 10.

FIG. 32 is a diagram illustrating an image displayed on the monitor.

FIG. 33 is a diagram illustrating an image displayed on the monitor.

FIG. 34 is a diagram illustrating an image displayed on the monitor.

FIG. 35 is a diagram illustrating an image displayed on the monitor.

FIG. 36 is a diagram illustrating an image displayed on the monitor.

FIG. 37 is a diagram illustrating an image displayed on the monitor.

### DETAILED DESCRIPTION OF THE PREFERRED EMBODIMENTS

Embodiments of a digital comic editor, a method and a non-transitory computer-readable medium storing a program according to the invention will be described below referring to the appended drawings.

[Configuration of a Content Delivery System]

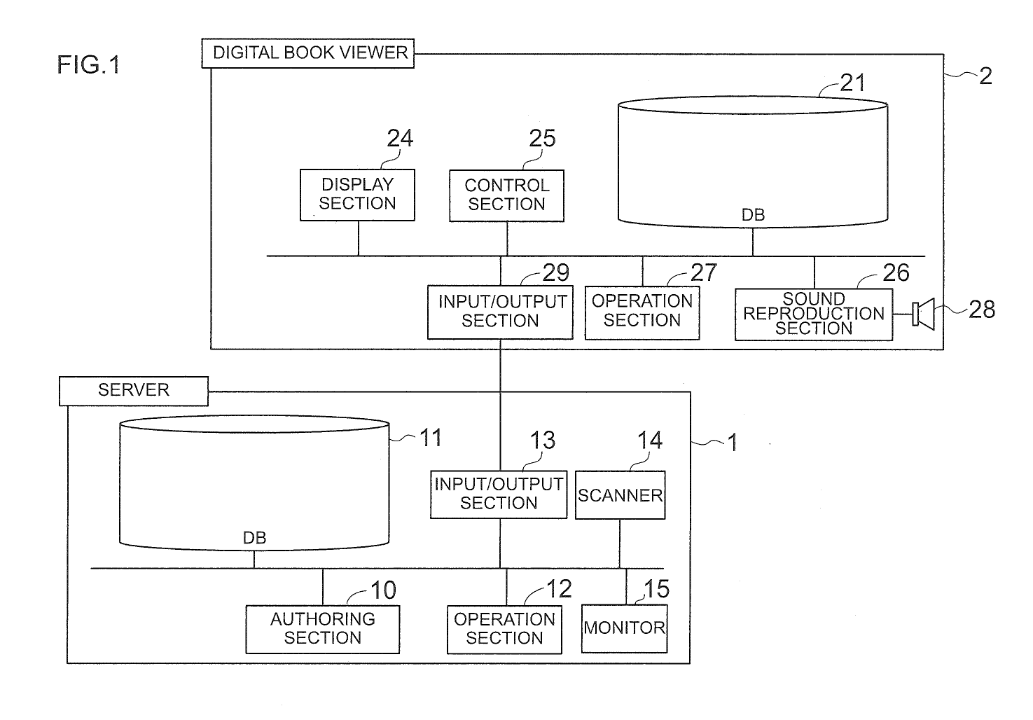

FIG. 1 illustrates a configuration of a content delivery system according to an embodiment of the invention. This system includes a server 1 which is configured of a computer (information processor), and a digital book viewer 2 which is configured of a smartphone or a tablet computer. Note that an unspecified number of digital book viewers 2 may access the server 1.

The server 1 includes an authoring section 10, a database (DB) 11, an operation section 12, an input/output section 13, a scanner 14, and a monitor 15, etc.

The authoring section 10 includes an information processor such as CPU and a storage storing a digital comic editing program or the like to perform various information processing in accordance with the digital comic editing program. The DB 11 is constituted of a storage medium such as a hard disk and a memory and the like. The operation section 12 includes an operation unit such as a keyboard, a mouse, a touch-pad and the like. The monitor 15 is a display unit constituted of a display device such as an LCD.

The authoring section 10 analyzes a content image to create several pieces of collateral information such as page information, frame information, coordinates of speech bubble, ROI information and the like, and creates master data for digital book, in which these pieces of data are associated with each other. Also, the authoring section 10 creates data optimized for each digital book viewer 2 from the master data. Detailed description of the authoring section 10 will be given later.

The DB 11 accumulates content files for storing the content image associated with a page number and collateral information thereof in a predetermined file format. The content images are original contents which are the data digitalized using the scanner 14 or the like. The original contents include comics, newspapers, articles of magazines, office documents (presentation documents, etc.), textbooks, reference books, which are set on the page basis. Also, each set of the content images is associated with its own page number.

The content images and the collateral information thereof are stored, for example, in an EPUB format. The content images may include their collateral information. The collateral information may include author of content, title, total number of pages, volume number, episode number, a holder of the right of publication (publisher) and the like.

The content image includes outline images and detailed images (high resolution data), and each image is prepared on the basis of page, frame or anchor point.

The collateral information collateral to the content image includes information input from the operation section 12, information of result of analysis made by the authoring section 10, or information input through the input/output section 13.

The digital book viewer 2 includes a database (DB) 21, a display section 24, a content display control section 25, a sound reproduction section 26, an operation section 27, a speaker 28, and an input/output section 29, etc.

The display section 24 is a display unit including a display device such as an LCD. The operation section 27 is an operation detection unit including a touch panel or the like. The operation section 27 is preferably laminated on the display section 24, and is capable of detecting various operations on the display section 24 such as single tap, double tap, swipe, long press or the like.

The sound reproduction section 26 is a circuit that converts sound-related information (information relevant to read sound and/or information relevant to accompanying sound) stored in the content file into sounds to outputs the same from the speaker 28.

The input/output section 29 is a unit that inputs a content file output from the input/output section 13 of the server 1. Typically, the input/output section 13 and the input/output section 29 is a communication unit, but it may be a write/read unit for a computer readable storage medium.

The DB 21 stores information same as the DB 11. That is, when the digital book viewer 2 makes a request to the server 1 to transmit a digital book, the server 1 exports a content file from the DB 11 to the DB 21 via the input/output section 29, and the content file is stored in the DB 21. However, the information in the DB 11 and the information in the DB 21 may not be completely identical to each other. The DB 11 is a library that stores various kinds of content images, for example, content images of each volume of comics of different authors in order to meet the requests from various kinds of users. The DB 21 stores at least content files relevant to the contents that a user of the digital book viewer 2 desires to browse.

The content display control section 25 controls the display of contents on the display section 24.

[Operation of the Content Delivery System]

(A) Creation Processing of Master Data

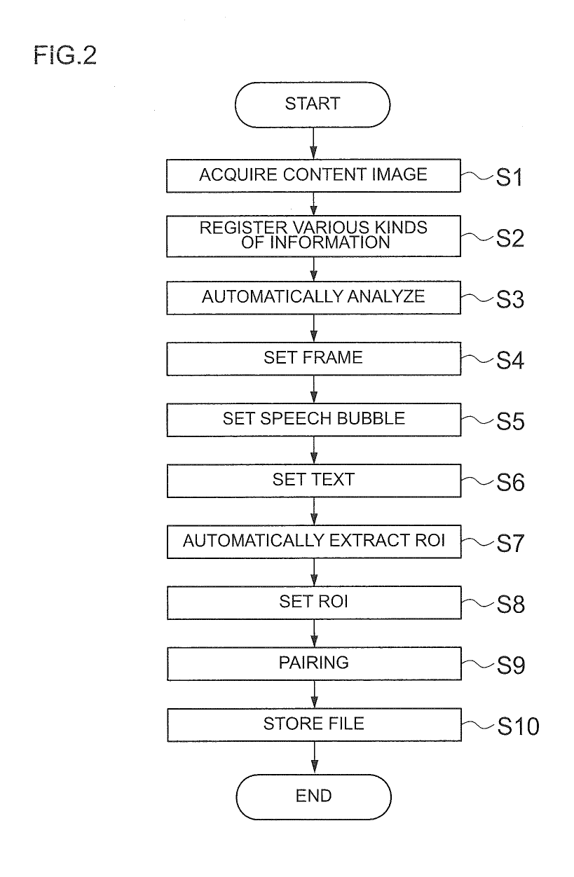

FIG. 2 is a flow chart illustrating the processing flow in which the authoring section 10 creates master data.

First, a content image is acquired and stored in the DB 11 (step S1). The server 1 acquires images of the entire page corresponding to the respective pages of the comic (high resolution images of, for example, 3000×5000 pixels or 1500×2000 pixels) via a storage media or a network; or acquires images by reading the comic by the scanner 14. The authoring section 10 acquires content images acquired by the server 1 in the above manner. When the content image is already stored in the DB 11, the authoring section 10 may acquire the content image stored in the DB 11.

In step S1, the authoring section 10 causes the monitor 15 to display the content image acquired in step S1 on a registration screen which is a screen for registering various kinds of information. When the user inputs various kinds of information through the operation section 12 in accordance with the instruction on the registration screen, the authoring section 10 acquires and registers the information in the DB 11 while associating the content image (step S2). The authoring section 10 creates an information file and stores the various kinds of information in the information file. The authoring section 10 makes a connection between the content image and the information file with each other to create the master data. The master data is stored in the DB 11.

The various kinds of information (page information) includes several pieces of information relevant to the content (content unique title ID, title name, author, publisher (holder of the right of publication), publication year, language and the like), information relevant to the page, page name, and information of page ID. The information relevant to the page unit information indicating whether the content image is a single page or a two-page spread, right-open/left-open, and size of original content.

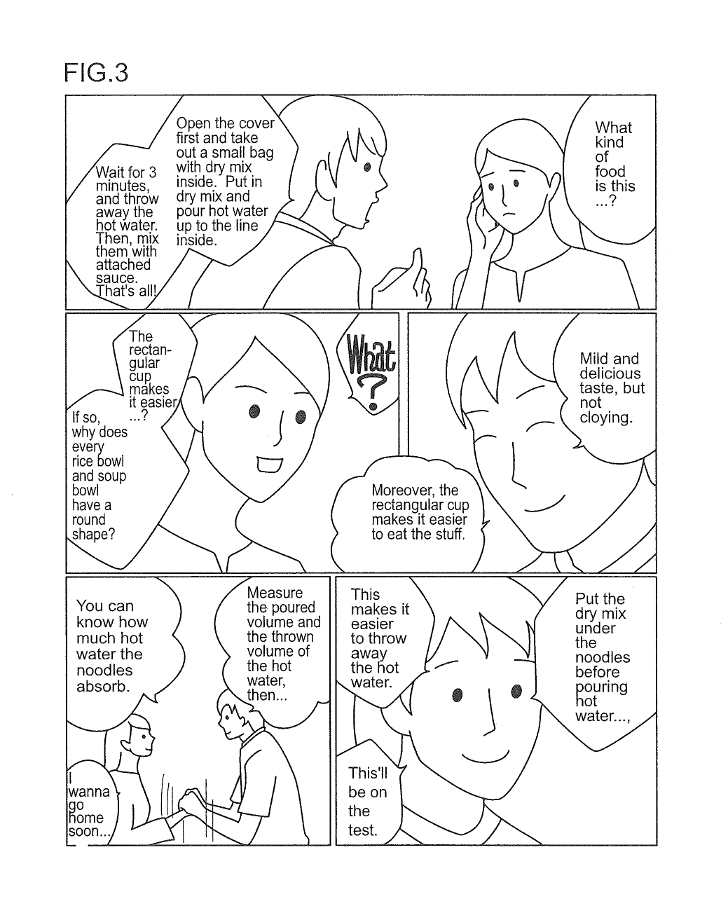

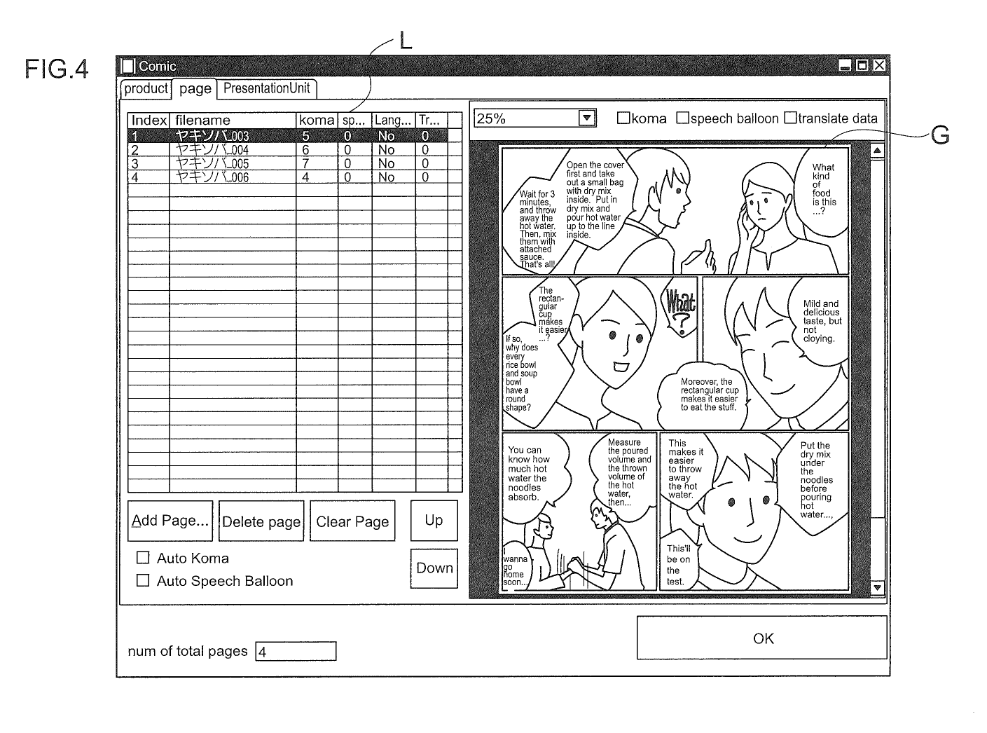

When a content image shown in FIG. 3 is acquired in step S1, the authoring section 10 displays a registration screen shown in FIG. 4 on the monitor 15. On the registration screen, a content image G is displayed at the right hand; and a list L of the acquired content images is displayed at the left hand. “Index” is a file ID which is automatically given to the acquired content image. In the list L, plural pieces of information of the acquired content images are displayed in the order of file IDs. Before registration, “0” is displayed in the columns other than “Index”.

When the user makes an input operation on any column of “filename”, “speaking”, “Language” and “Translation” through the operation section 12, the authoring section 10 displays the input character information in the list L and stores the same in the DB 11. “filename” means a file name; “speaking” indicates existence of sound information; “Language” indicates a language of the character information included in the content image; “Translation” indicates existence of translation into multiple languages of the character information included in the content image. “koma” indicates number of the frames, at this point, “0” is displayed (automatically input later).

The authoring section 10 automatically analyzes the content image (step S3). The automatic analysis is executed when the user checks (select) a check box of “Auto Koma” and/or “Auto Speech Balloon” and presses OK button A through the operation section 12 in the registration screen shown in FIG. 4. In this embodiment, a description is made assuming that “Auto Koma” and “Auto Speech Balloon” are selected.

When “Auto Koma” is selected, the authoring section 10 automatically detects frames based on information on the lines included in the content image. The infomiation on the lines included in the content image is acquired by, for example, by recognizing a portion in which a region having a stronger contrast in the content image appears linearly as a line.

When “Auto Speech Balloon” is selected, the authoring section 10 extracts a text from the content image and determines a closed region enclosing the periphery of the text as a speech bubble region; thereby a speech bubble included in the content image is extracted. An optical character reader (OCR) included in the authoring section 10 extracts the text. The text read by the OCR is sorted based on the orientation of the characters. For example, when the words run vertically, the words are sorted from the top to the end of the line and from a line at the right toward the line at the left.

The frame detection and the speech bubble extraction may be performed based on machine learning. For example, detection accuracy of the frame and outer edge of the speech bubble, a determination threshold of adequateness of the frame region other than rectangle and the speech bubble may be empirically set based on a learning sample comic.

The information file stores frame information on the frame, speech bubble information on the speech bubble, and text information on the text.

The frame information includes frame region information. The frame region information is information indicating a frame region which includes the number of the frames included in the page, coordinate data indicating each vertex on the polygonal frame boundary enclosing the frame and a shape of each frame. The frame region information may be vector data indicating a frame boundary line or mask data indicating a frame region. The frame information further includes frame order information or the like relevant to the frame order (reproduction order) of each frame. An appropriate pattern of frame order is selected from some transition patterns of frame order such as, for example, from top right to bottom left, or from top left to bottom right of the page, and a shift direction (horizontal direction or vertical direction) or the like based on information on right-open/left-open page, information on content representing a language, a frame allocation detected from the frame region information and the like. Thus, frame order is automatically determined in accordance with the selected transition pattern.

The speech bubble information includes speech bubble region information. The speech bubble region information is information indicating regions where speech bubbles exist within a page unit (or frame unit), which includes position information (for example, coordinate data) indicating plural points corresponding to a speech bubble shape on a line, a shape of the speech bubble (for example, vector data), position and direction of a start point of a speech bubble (vertex of speech bubble), and a size of the speech bubble. The speech bubble region information may be bitmap information (mask data) indicating a full region (range) of the speech bubble. The speech bubble region information may be represented by a specific position (for example, center position) of the speech bubble and the size of the speech bubble. The speech bubble information further includes, information on a text included in the speech bubble, an attribute of the line of the speech bubble (dashed line, solid line etc.), an ID information of a speaker of the speech bubble, and a frame to which the speech bubble belongs.

The text information includes text region information and information about the content of text. The text region information includes position information (for example, coordinate data) indicating each vertex on a polygonal outer peripheral edge of a text region on a line. Note that the text region information may be vector data indicating the outer peripheral edge of the text region or bitmap information (mask data) indicating the text region (range).

The information on the content of the text includes text (sentence) character attribute information specified by the OCR, number of lines, line spacing, character spacing, display switching method, language, vertical writing/horizontal writing, differentiation of reading direction and the like. The character attribute information includes a character size (the number of points etc.) and character classification (font, highlighted character etc.). The text information includes a dialog of a speaker in the speech bubble. The text information also includes a translation sentence and the language of various languages (translation sentences of 2 or more languages are available) corresponding to original dialog disposed in the speech bubble.

The authoring section 10 stores, as an association information, information in which the text and the speech bubble are associated with each other and information in which the speech bubble or text and the frame are associated with each other in an information file. Since the text is extracted during the extraction of the speech bubble, the text is associated with the speech bubble from which the text is extracted. By comparing the coordinates included in the speech bubble information with the coordinates included in the frame information, it is determined in which frame the speech bubble included. Thus, the speech bubble is associated with a frame in which the speech bubble is included. When no closed region is found around a text, it is a case when only the characters are included in the frame. Thus, the text is associated with a frame in which the text is included.

The authoring section 10 updates the master data by storing the frame information, the speech bubble information and the text information in the information file. When all of the processing of the step is made manually, enormous workload is required. By automatically performing the processing as described above, the master data is created efficiently.

The authoring section 10 displays the original content image and the detection result of the frame of the content image which is automatically analyzed in step S3 on the monitor 15 next to each other, receives a correction input of the frame detection result through the operation section 12, and performs frame setting based on the result (step S4).

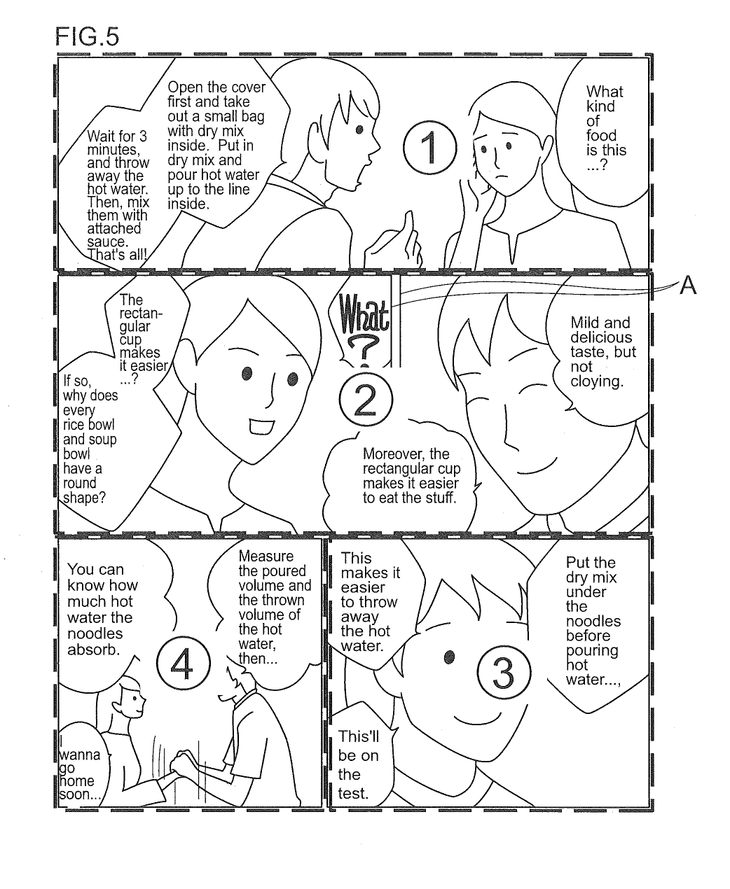

The processing in step S4 is described in detail. FIG. 5 illustrates a frame detection result by the automatic analysis of a content image (file ID: 1, file name: yakisoba_{—}003) shown in FIG. 3. Actually, the content image shown in FIG. 3 and the frame detection result shown in FIG. 5 are displayed on the monitor 15 next to each other. However, only the frame detection result shown in FIG. 5 may be displayed. The authoring section 10 displays the frame detection result based on the information file. The frame detection result is displayed with a thick dotted line with boundary line of each frame (hereinafter, referred to as frame boundary line) being overlapped with the contrast image; and in the center of each frame, a frame order indicating the reading order of the frame is displayed. With this, the user can check the present frame region information (frame allocation) and frame order.

When a predetermined frame is selected by the user, the authoring section 10 changes the color of the frame boundary of the frame to a color different from the color of other frame boundary line (for example, selected frame is red line; unselected frame is blue line), and starts to receive a correction input to a selected frame. With this, the user can check the frame to be edited.

(1) Increasing Frames

In a state a frame is selected, when a certain position in the frame is selected, the authoring section 10 adds a frame boundary line adjacent to the selected position, and accompanying this, updates the frame order. In step S3, although a line is extracted and recognized, if the line cannot be recognized as a frame boundary line, an erroneous recognition is caused. When a certain position in the frame is selected, the authoring section 10 extracts a line adjacent to the position at which a selection instruction is input which is recognized as a line, but is not recognized as a frame boundary line, a new frame boundary line is added by recognizing the line as a frame boundary line.

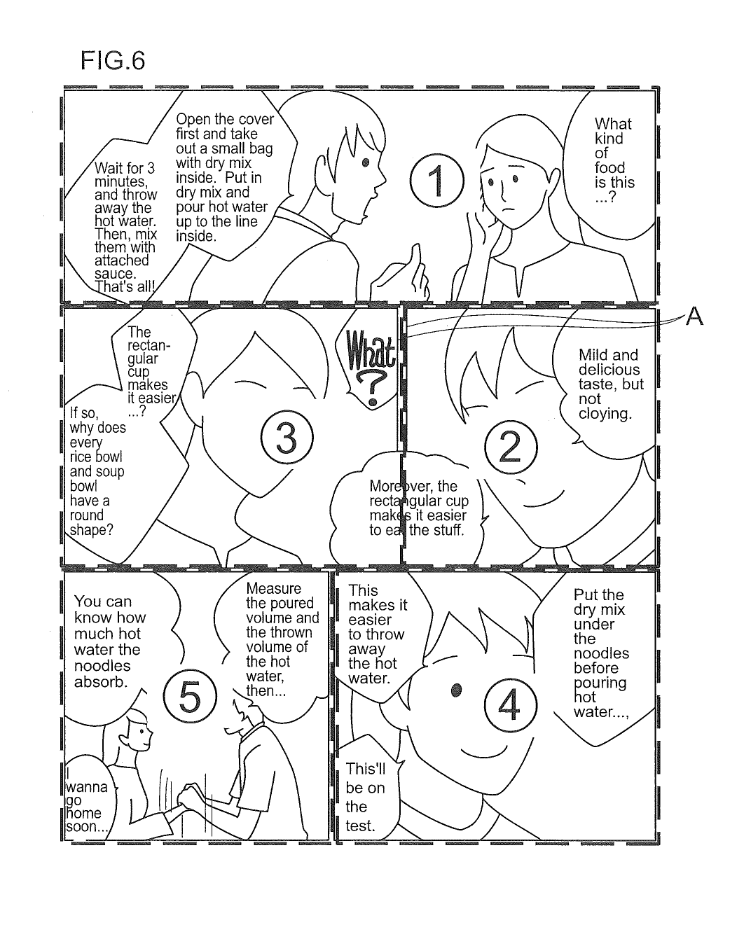

In the frame detection result shown in FIG. 5, in the frame order 2 at the center of the content image, although actually two frames exist, they are recognizes as a single frame. Therefore, when the user selects a point adjacent to lines A at the center of the frames through the operation section 12, the authoring section 10 divides the frame at the center of the content image into a frame of frame order 2 and a frame of frame order 3 as shown in FIG. 6.

Accompanying the increase of the frames, the authoring section 10 modifies the frame order. In this case, the frame order 3 of the frame in FIG. 5 is changed to 4, and the frame order 4 in FIG. 5 is changed to 5.

(2) Deleting Frame

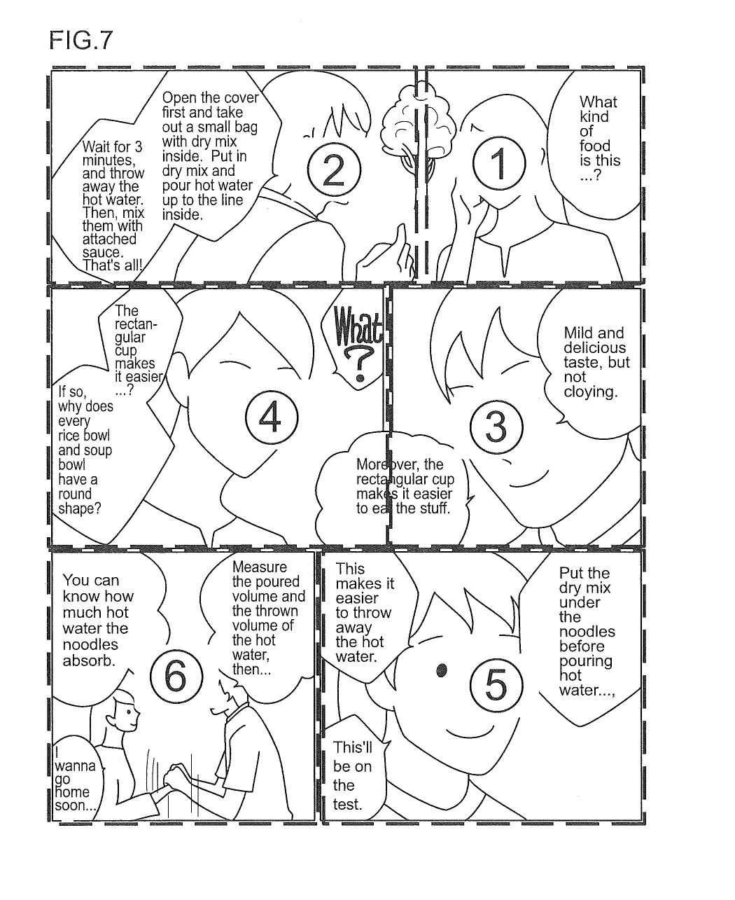

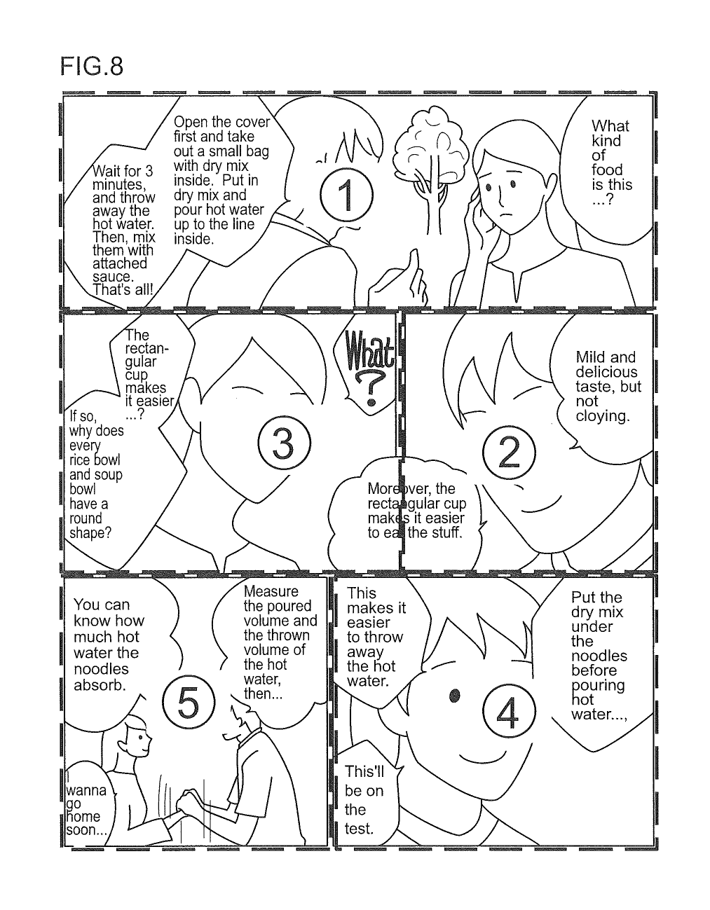

In an example shown in FIG. 7, as a result of false recognition that a trunk of a tree B is a line dividing the frame, although the upper portion of the content image is divided into two, actually, the upper frame of the content image is a single frame. An image shown in FIG. 7 is displayed on the monitor 15, in a state that the frame with frame order 1 or the frame with frame order 2 is selected, when the user selects the frame boundary line between the frame with frame order 1 and the frame with frame order 2 through the operation section 12, the authoring section 10 deletes the frame boundary line between the frame with frame order 1 and the frame with frame order 2 in FIG. 7, and modifies the upper frames of the content image into a single frame with frame order 1 as shown in FIG. 8.

Accompanying the deletion of the frame, the authoring section 10 modifies the frame order. In this case, the frame order 3 in FIG. 7 is changed to 2; the frame order 4 is changed to 3; and the frame order 6 is changed to 4.

When adding or deleting the frame boundary line, the added frame boundary line and the frame boundary line to be deleted may be displayed to distinguishable from other frame boundary lines. With this, the user can recognize which frame boundary line is added and which frame boundary line is deleted.

(3) Modification of Frame Boundary Line

When selected frame is double-clicked, the authoring section 10 receives correction input of the number of vertexes and coordinates. With this, shape and size of frame can be modified.

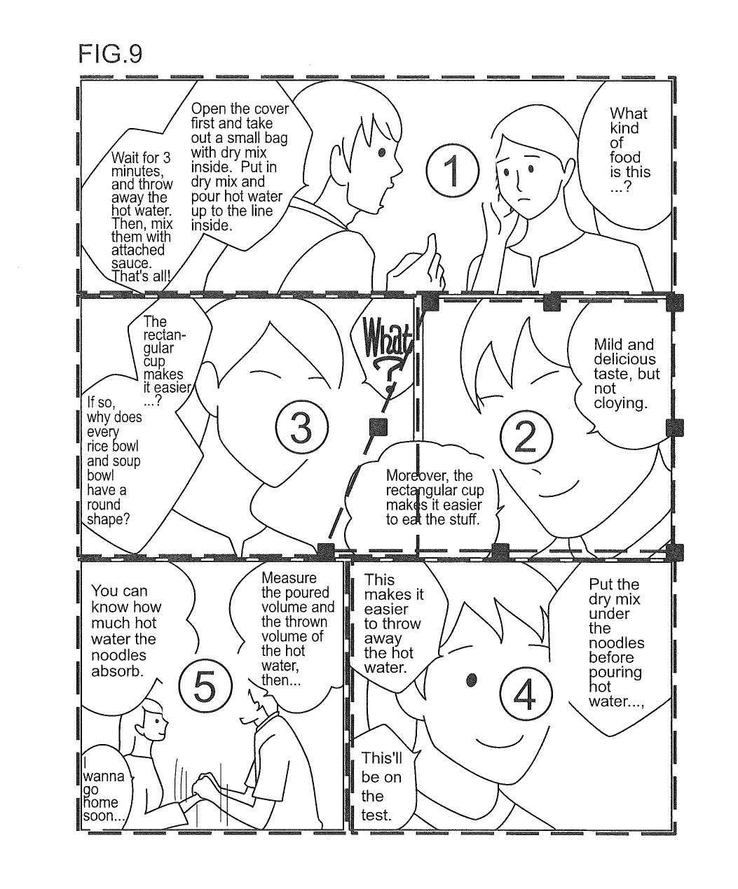

When the selected frame is double-clicked, a modification screen of the frame boundary line is displayed as shown in FIG. 9. A frame is represented with a polygonal shape having three or more vertexes, and a frame boundary line is represented with a line connecting three or more vertexes. In FIG. 9, since the frame has a square shape, total eight vertexes of the vertexes of the square shape and at rough center of the edges are displayed.

When the user inputs an instruction by double-clicking at a desired position on the frame boundary line through the operation section 12, a vertex is added to the position. Also, when the user inputs an instruction by double-clicking on a desired vertex through the operation section 12, the vertex is deleted.

When the user drags a desired vertex through the operation section 12, the vertex is shifted as shown in FIG. 9, the shape of the frame boundary line is modified. By repeating this operation, the shape and the size of the frame boundary line can be changed.

(4) Modification of Frame Order

When the user double-clicks on a number indicating the frame order through the operation section 12, the authoring section 10 receives the modification of the frame order, and modifies the frame order with the number input through the operation section 12. With this, when the automatically analyzed frame order is not correct, the frame order is modified.

When frame setting is made, the authoring section 10 modifies the frame information of the information file accordingly. When an instruction to display the registration screen is made after frame setting, the authoring section 10, displays the input number of the frame in a column of “koma” of the list L on the monitor 15. When the result shown in FIG. 6 is set, 5 is input in the “koma” with file ID of 1 as shown in FIG. 4.

When frame setting is made (in step S4), the authoring section 10 displays the original content image and the extraction result of the speech bubble of the content image which is automatically analyzed in step S3 on the monitor 15 next to each other, receives the correction input of the extraction result of the speech bubble through the operation section 12 and sets the speech bubble based on the result (step S5).

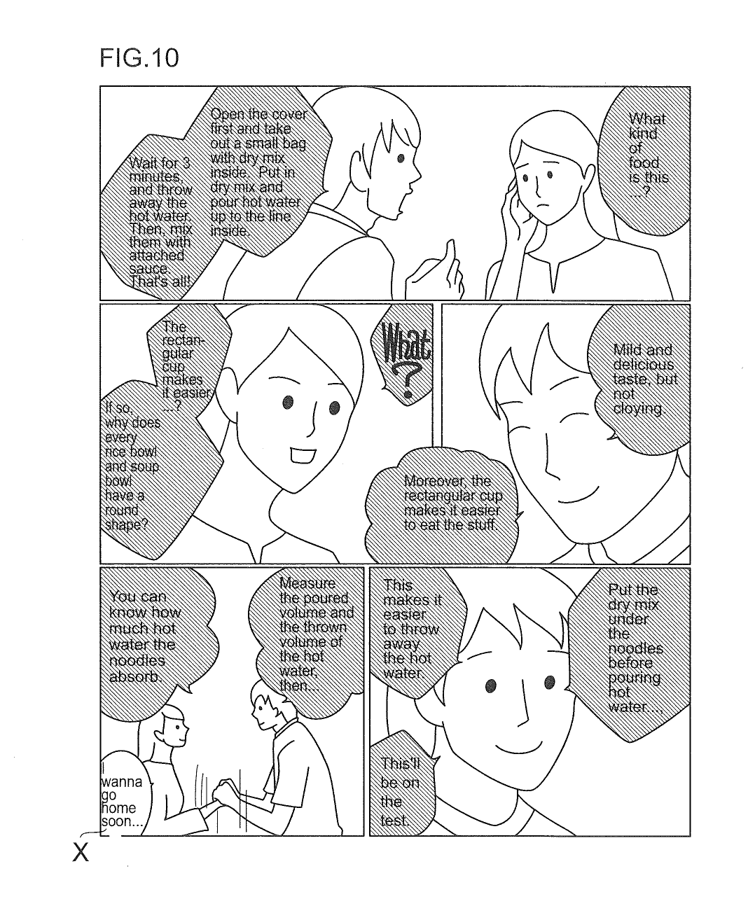

The processing in step S5 is described in detail. FIG. 10 is an extraction result of speech bubbles in the content image (file ID: 1, file name: yakisoba_{—}003) shown in FIG. 3 obtained by automatic analysis. Actually, the content image shown in FIG. 3 and the speech bubble extraction result shown in FIG. 9 are displayed on the monitor 15 next to each other. However, only the speech bubble extraction result shown in FIG. 9 may be displayed. The authoring section 10 displays the speech bubble extraction result based on the information file. The authoring section 10 displays a covered over image of the extracted speech bubble on the monitor 15 so that the extracted speech bubble can be distinguished from other region. In FIG. 9, as the image indicating the speech bubble regions, an image in which the extracted speech bubbles are covered over by hatching is shown. An image in which the outer periphery edges of the speech bubbles are thickly drawn may be displayed as an image indicating the speech bubble regions.

(1) Addition of Speech Bubble

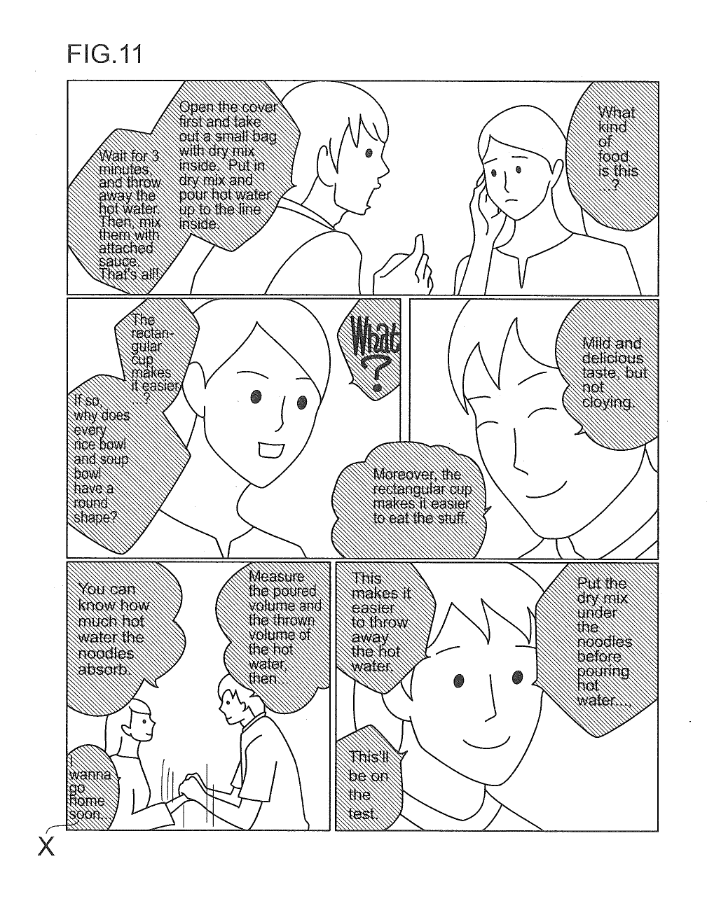

In the extraction result shown in FIG. 10, since a part of the boundary line of a speech bubble X at the bottom left is broken, it is not detected automatically. The user connects the portion where boundary line is broken through the operation section 12 to foam a closed region. After that, when the user selects the closed region through the operation section 12 and indicates the recognition, the authoring section 10 automatically recognizes the selected closed region as a speech bubble. As a result, hatching is also displayed on the speech bubble X as shown in FIG. 11, and is set as a speech bubble same as the other speech bubbles.

(2) Deleting Speech Bubble

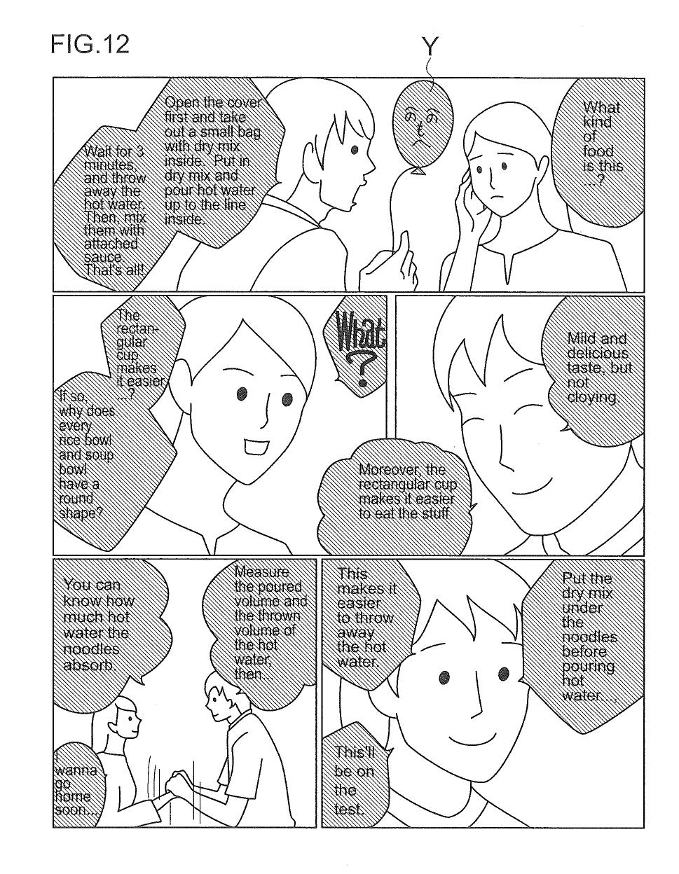

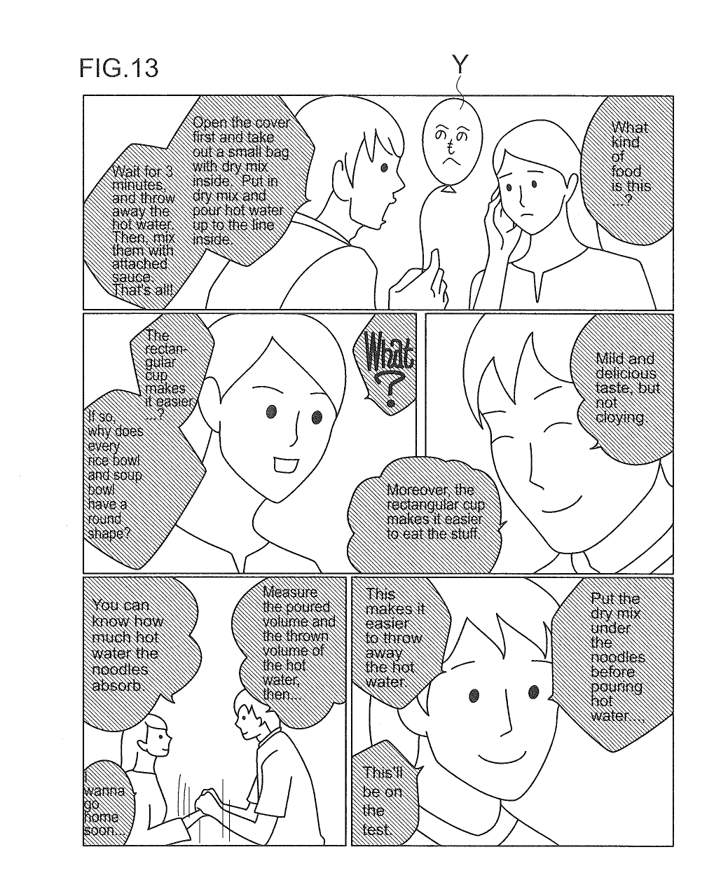

Since a balloon Y is a closed region, in the extraction result shown in FIG. 12, although the balloon Y is not a speech bubble, it is extracted as a speech bubble. This is caused from a false recognition of the characters in the balloon Y as a text. When the user selects the balloon Y through the operation section 12, the authoring section 10 deletes the automatically selected closed region (in this case, inside of the balloon Y) from the speech bubble. As a result, hatching is deleted from the balloon Y as shown in FIG. 13.

(3) Modifying Speech Bubble Region when Speech Bubble is not Detected Clearly

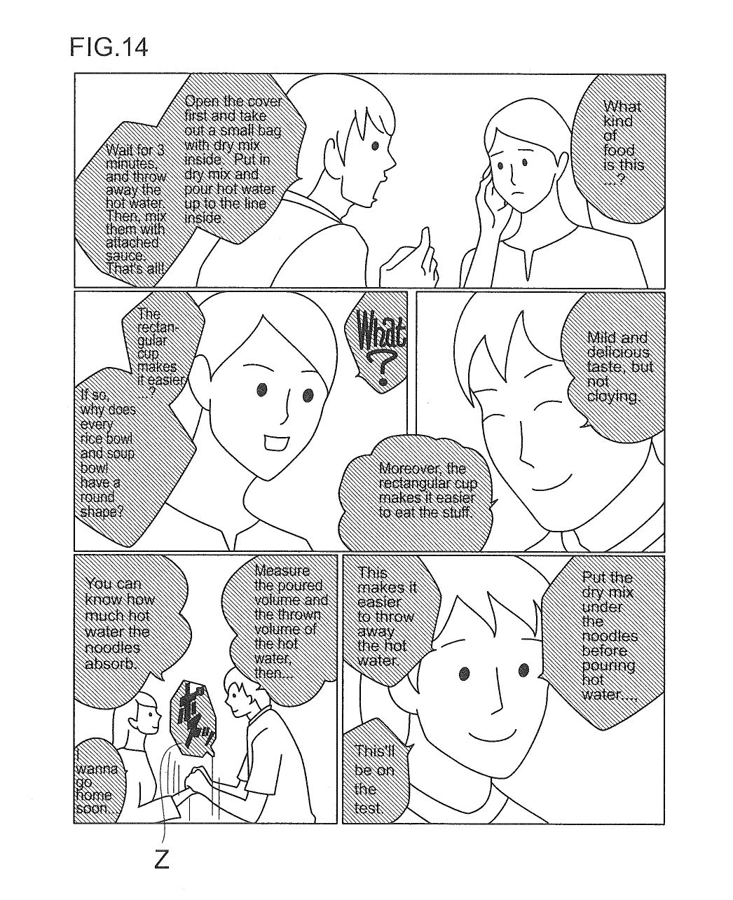

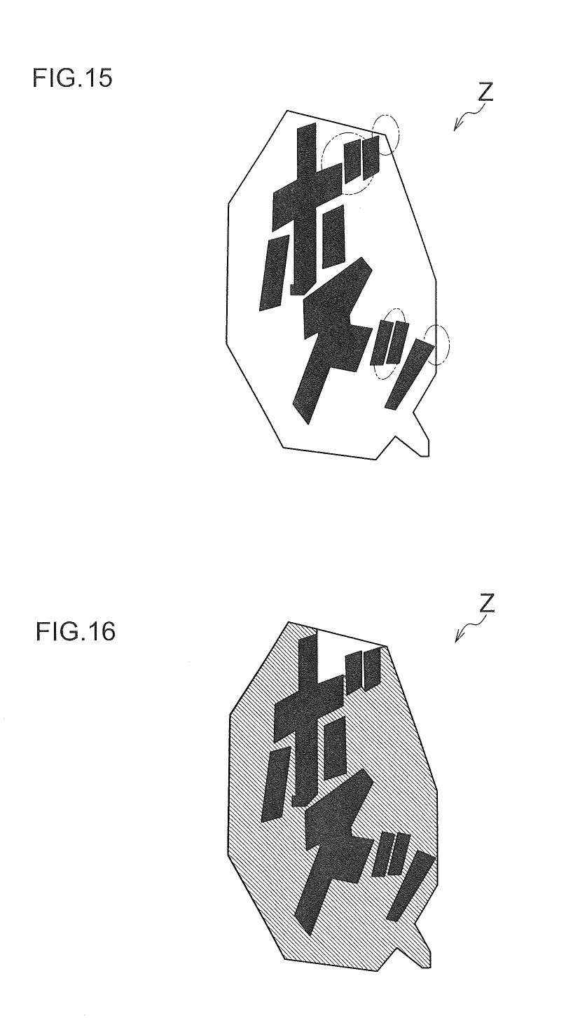

In an extraction result shown in FIG. 14, a part of a speech bubble Z at the top right is not extracted. This is caused when a character in the speech bubble is too close to the boundary line or in contact therewith as indicated with a chain line in FIG. 15; or when the characters in a speech bubble are too close to each other or in contact with each other as indicated with a two-dot chain line shown in FIG. 15.

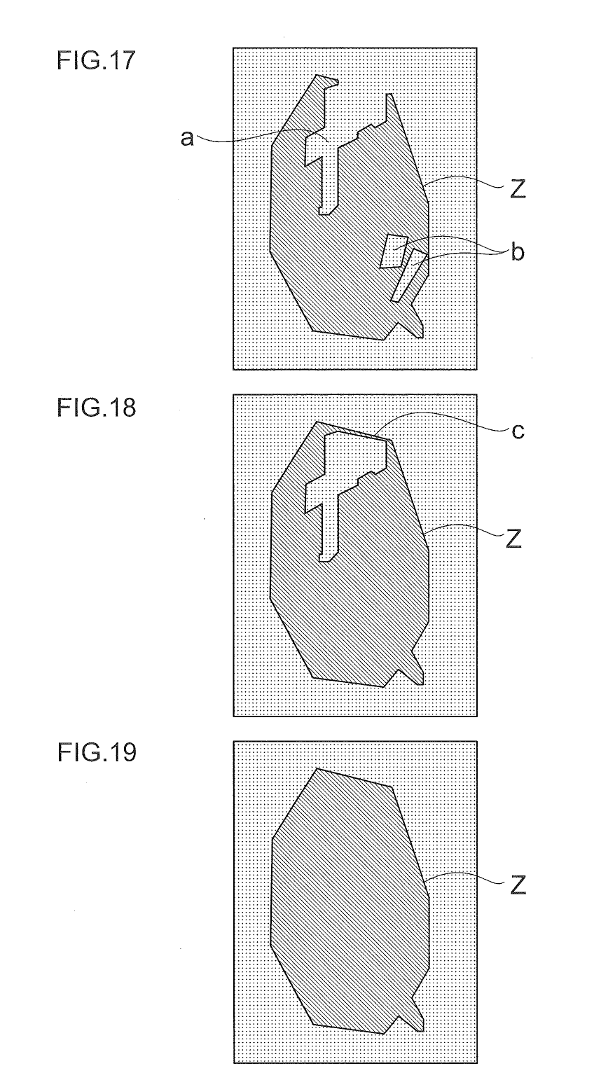

FIG. 16 is an enlarged view of the extraction result of the speech bubble Z shown in FIG. 14; FIG. 17 illustrates the extraction result shown in FIG. 16 from which characters are deleted. As shown in FIG. 17, in the speech bubble Z, a part of the boundary line is in contact with the character (FIG. 17-a); a part of the characters runs off the speech bubble (FIG. 17-b). Therefore, when the user selects closed region b in the speech bubble through the operation section 12, the authoring section 10 automatically determines the closed region b as a speech bubble (refer to FIG. 17) as shown in FIG. 18. Also, when the user adds a boundary line c of the speech bubble through the operation section 12 as shown in FIG. 18, the authoring section 10 automatically determines the closed region generated by the boundary line c (refer to FIG. 18) as a speech bubble as shown in FIG. 19. As a result, the speech bubble, which was not detected clearly, is extracted correctly as shown in FIG. 19.

When correction input of the extraction result of the speech bubble is made as described above, the authoring section 10 modifies the speech bubble information in the information file accordingly.

After completing the speech bubble setting (step S5), the authoring section 10 displays the original content image and the text recognition result of the content image which is automatically analyzed in step S3 on the monitor 15 next to each other, and receives correction input of the recognition result of the text made through the operation section 12 and performs the text setting based on the result (step S6).

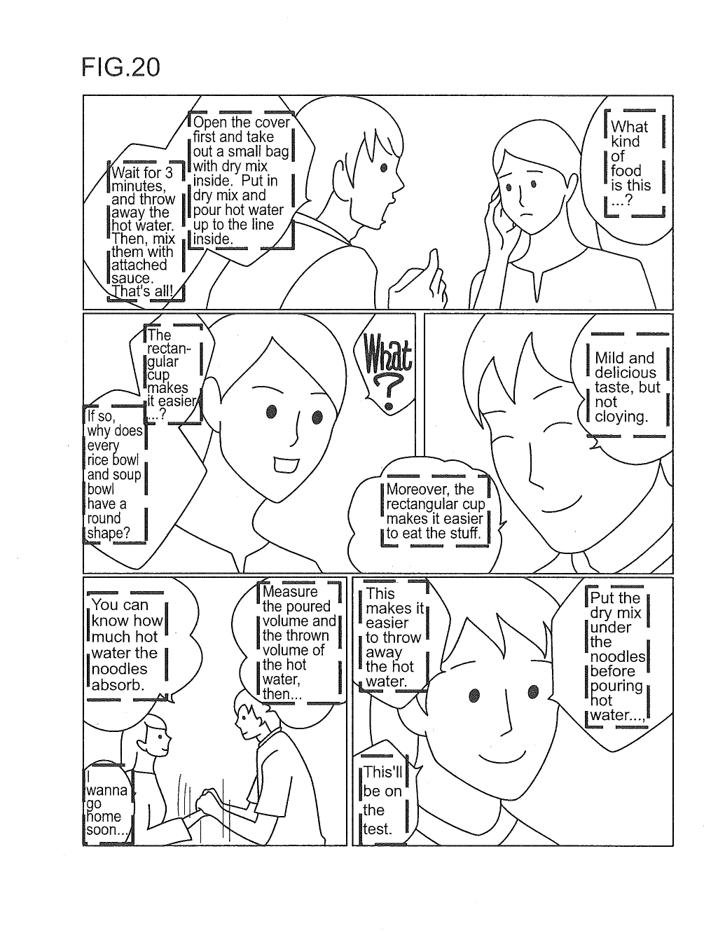

The processing in step S6 is described in detail. FIG. 20 illustrates a text recognition result obtained by automatic analysis of a content image (file ID: 1, file name: yakisoba_{—}003) shown in FIG. 3. Actually, the content image shown in FIG. 3 and the recognition result shown in FIG. 20 are displayed on the monitor 15 next to each other. However, only the text recognition result shown in FIG. 20 may be displayed. The authoring section 10 displays the extraction result of the text based on the information file. The authoring section 10 displays an image in which the outer periphery edge of the text region in a thick line on the monitor 15 thereby the text region and other regions can be recognized. In FIG. 20, an image in which the outer periphery edge of the text region is drawn with a thick line is shown as the image indicating the text region. However, an image indicating text region, in which the text region is translucently covered over may be displayed. By covering over translucently, the user can recognize the text.

(1) Adding Text

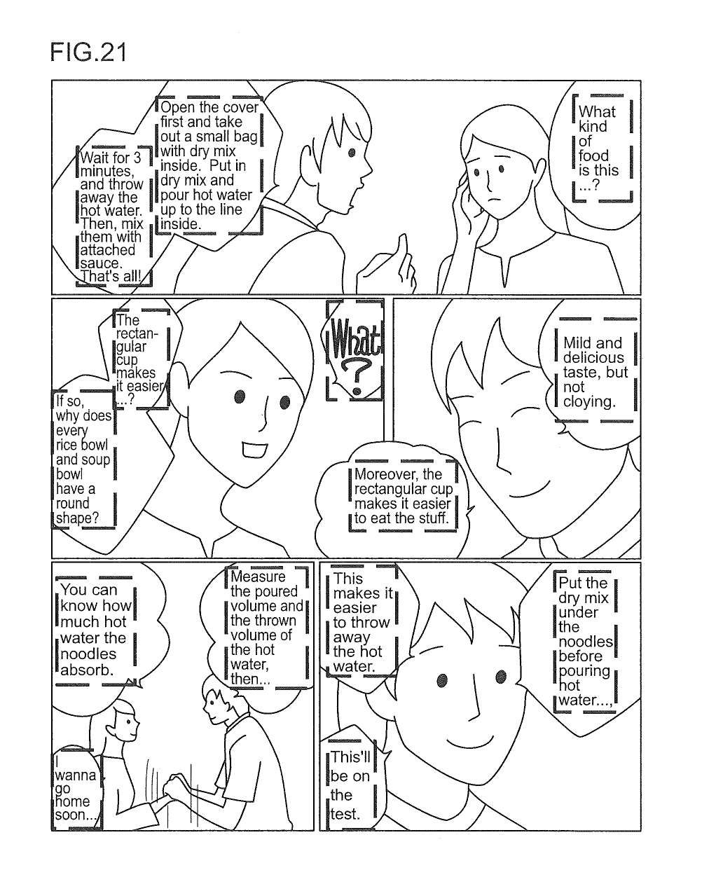

In FIG. 20, a text “What?” of hand written characters is not recognized. When the user encloses “What?” through the operation section 12 to instruct to recognize the same, the authoring section 10 recognizes the closed region enclosing “What?” as a text region. As a result, “What?” is also set as a text region as shown in FIG. 21, and thus, the text region information is acquired.

After the text region is set, the character data is specified by the optical character reader of the authoring section 10. When the character data is not specified, the authoring section 10 prompts the user to input, and the user inputs the characters through the operation section 12. With this, the information on the content of the text is acquired.

When correction input of the text extraction result has been made as described above, the authoring section 10 modifies the text information in the information file.

(2) Deleting Text

When a text region is erroneously recognized, the user selects a desired position on the erroneous text region through the operation section 12 and gives an instruction to perform recognition. Then, the authoring section 10 automatically deletes the text region selected from the information file. The authoring section 10 also deletes information on the text content of the deleted text region from the information file.

When the text setting (step S6) is completed, the authoring section 10 automatically extracts a region of interest (hereinafter, referred to as ROI) from the original content image (step S7). ROI means an item to be always displayed on the digital book viewer 2, which is a face (or a region equivalent to face) of a character in the original comic of the content image. The character includes not only a person but also an animal, a non-living material such as a telephone, a PC, electronic equipment and a robot.

The authoring section 10 includes a known image analysis technology, for example, a face detection unit which automatically detects a face of a character by using a face detection technique, and the face detection unit detects the face of the character from the content image. The authoring section 10 sets a polygonal shape region enclosing the detected face as a region of interest. The position, size, type of content elements such as animal, building, vehicle and other objects may be automatically detected based on the feature amount of information on the images by using known image analysis technology.

The authoring section 10 stores region of interest information which is information on the region of interest (ROI) in the information file. The region of interest information may be coordinate data indicating each vertex on a polygonal outer peripheral edge of the ROI, vector data indicating a shape of the ROI or an outer periphery edge of the ROI, or mask data indicating ROI. The region of interest information further includes information on the characters included in the ROI (for example, automatically given character ID). Also, the region of interest information may include priority order, important degree to display, ID information (name etc.) of the character, character's attributes (sex, age etc.) and the like.

When the automatic extraction (step S7) of the ROI has completed, the authoring section 10 updates the association information stored in the information file by using the information of the extracted ROI. That is, the ROI information is further associated with the association information for associating the speech bubble and the text, and the ROI information is further associated with the association information for associating the speech bubble and the text. Note that the association information may associate two or more pieces of information from among frame information, speech bubble information, text region information, and region of interest information. The ROI information is not necessarily associated.

Next, the authoring section 10 receives correction input of the ROI extraction result and performs ROI setting based on the result (step S8).

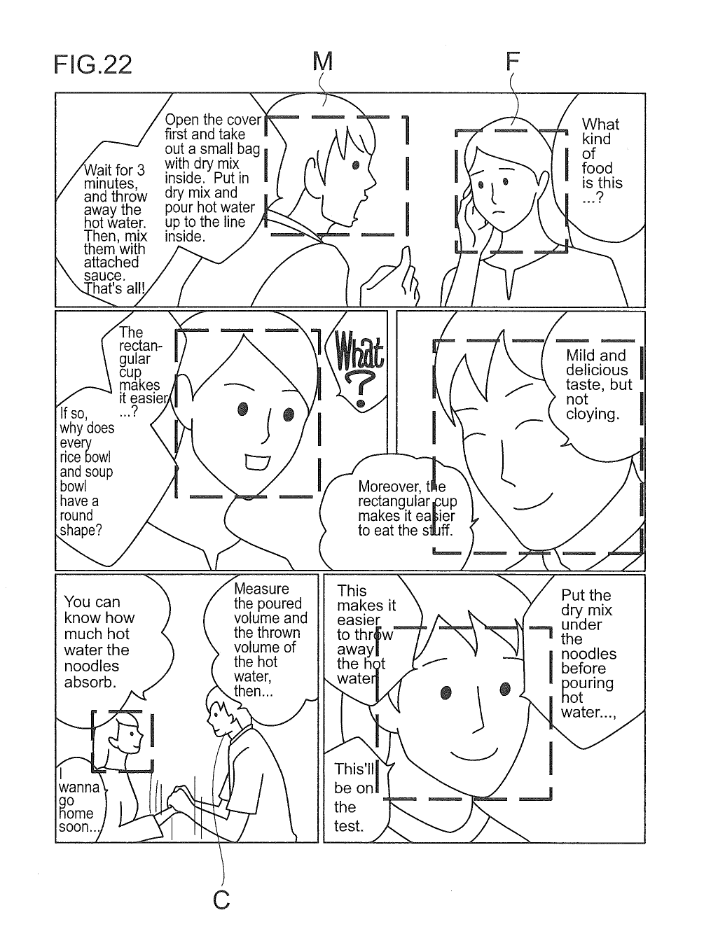

The processing in step S8 is described in detail. FIG. 22 shows a ROI extraction result made through automatic analysis of the content image shown in FIG. 3 (file ID: 1, file name: yakisoba_{—}003). Actually, the content image shown in FIG. 3 and the recognition result shown in FIG. 22 are displayed next to each other on the monitor 15. However, only the ROI extraction result shown in FIG. 22 may be displayed. The authoring section 10 displays the ROI extraction result based on the information file. The authoring section 10 displays the image with the outer periphery edge of the ROI thickly drawn on the monitor 15, to facilitate recognition of the ROI and other regions. In FIG. 22, the image in which the outer periphery edge of the ROI is thickly drawn is shown as an image representing the ROI. The translucently covered over ROI may be displayed as the image representing the ROI region. By translucently covering over, the user can recognize the characters.

(1) Adding ROI

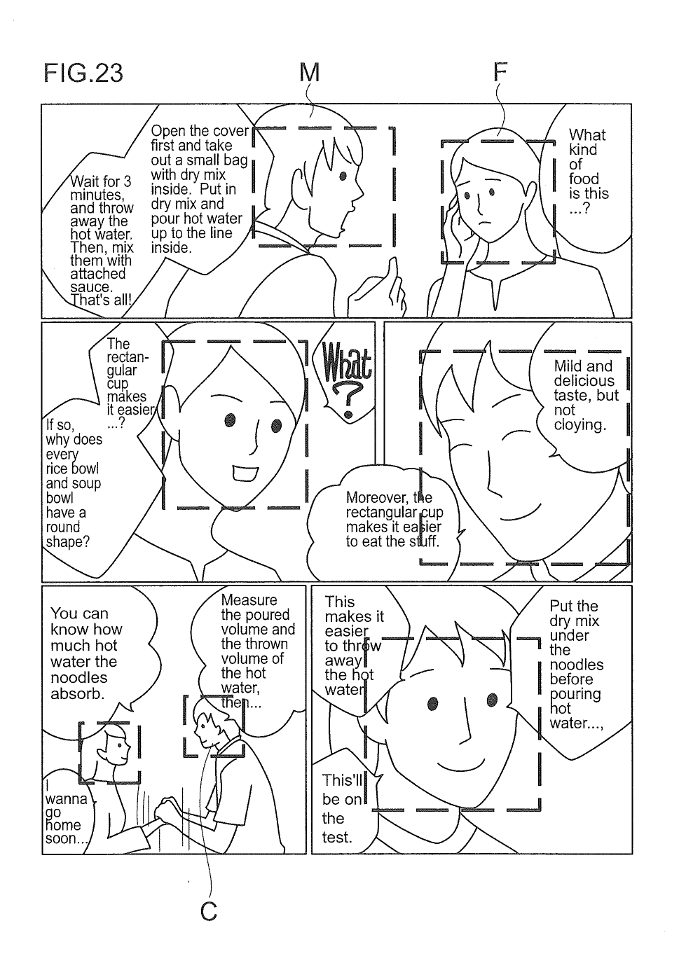

In FIG. 22, the characters include a man M and a woman F, a face C facing leftward of man M turning his head to a side is not recognized. When the user selects a desired position on the face C facing leftward of the man M turning his head to a side through the operation section 12 and gives an instruction to perform recognition, the authoring section 10 recognizes a closed region including the indicated position as the ROI. Also, the authoring section 10 modifies the region of interest information in the information file accordingly. As a result, an image representing the ROI is displayed on the face C facing leftward of the man M as shown in FIG. 23.

(2) Deleting ROI

When the ROI is erroneously extracted, the user selects a desired point on an incorrect ROI through the operation section 12 and gives an instruction to recognize. The authoring section 10 automatically deletes the region of interest information selected from the information file. With this, the image representing erroneous ROI is deleted from the monitor 15.

When the ROI setting is performed, the association information stored in the information file is updated according to the setting.

When the ROI setting (step S8) is completed, the authoring section 10 performs pairing setting (association setting) (step S9).

In the association setting, the ROI representing a person, for example, is associated with a speech bubble which is considered as a dialogue of the person. When there is a plurality of ROIs, the association is performed after judging that there is an association with an ROI closest to a speech bubble, and the association is performed after judging that there is an association with an ROI existing in the direction of the speech bubble. However, these judgments are erroneous in some cases. Even when the ROI cannot be appropriately extracted or when dialogues of a plurality of ROIs are mixed in one speech bubble, there is a possibility of making a mistake in the association setting.

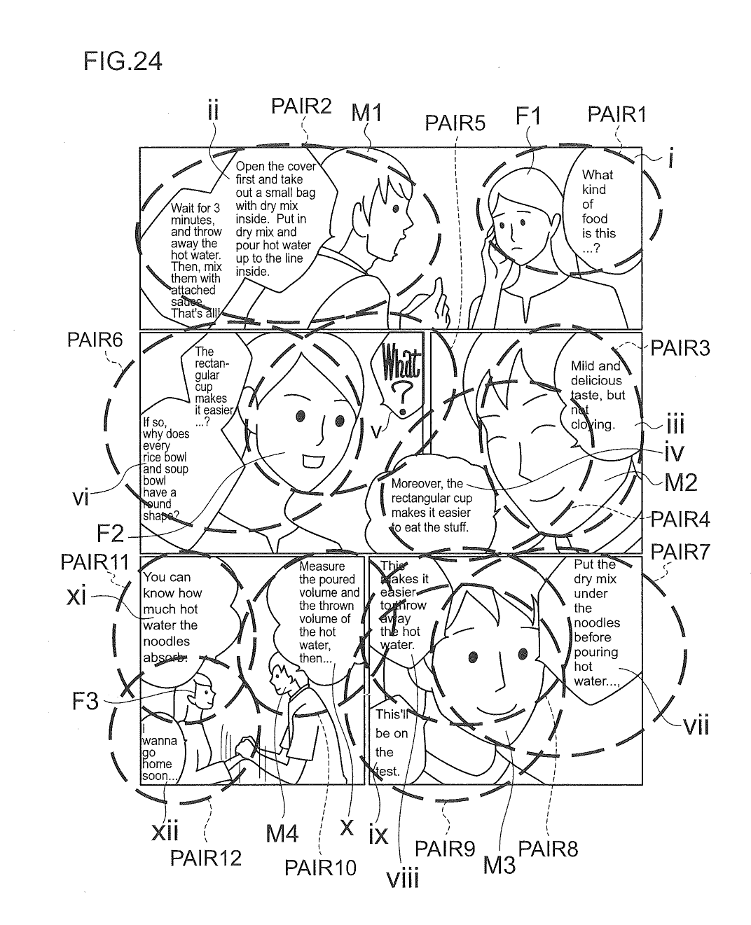

FIG. 24 is a diagram illustrating an example in which dashed circles each representing that speech bubbles and ROIs which are associated with each other based on the association information stored in the information file are superimposingly displayed on the image on the monitor 15.

In FIG. 24, speech bubbles i-xii are included as the speech bubble; a woman F (F1-F3) and a man M (M1-M4) are included as the ROI. Although the woman F1-F3 is all the identical person (woman F), the expression of woman F1-F3 is employed for the sake of description. Likewise, although the man M1-M4 is all the identical person (man M), the expression of man M1-M4 is employed for the sake of description.

In the case shown in FIG. 24, the speech bubble i and the woman F1 are set as pair 1; the speech bubble ii and the man M1 are set as pair 2; the speech bubble iii and the man M2 are set as pair 3; the speech bubble iv and the man M3 are set as pair 4; the speech bubble v and the woman F2 are set as pair 5; the speech bubble vi and the woman F2 are set as pair 6; the speech bubble vii and the man M3 are set as pair 7; the speech bubble viii and the man M3 are set as pair 8; the speech bubble ix and the man M3 are set as pair 9; the speech bubble x and the man M4 are set as pair 10; the speech bubble xi and the woman F3 are set as pair 11; and the speech bubble xii and the woman F3 are set as pair 12, and dashed circles are superimposed and displayed to enclose each pair.

When the user selects an image in which a predetermined pair is enclosed with a dashed line through the operation section 12, the authoring section 10 receives the modification of the pair.

In the example illustrated in FIG. 24, the speech bubble xi is associated with the woman F3 closest to the speech bubble xi in the association setting in the authoring section 10. However, in practice, the speech bubble xi should be associated with the man M4, instead of the woman F3. Accordingly, there is a need to make a correction to the pair 11.

When the user double-clicks the pair 11 through the operation section 12, the pair 11 gets ready to be edited. When the speech bubble xi and the man M4 are selected, the authoring section 10 reset the speech bubble xi and the man M4 as the pair 11, and modifies the information file.

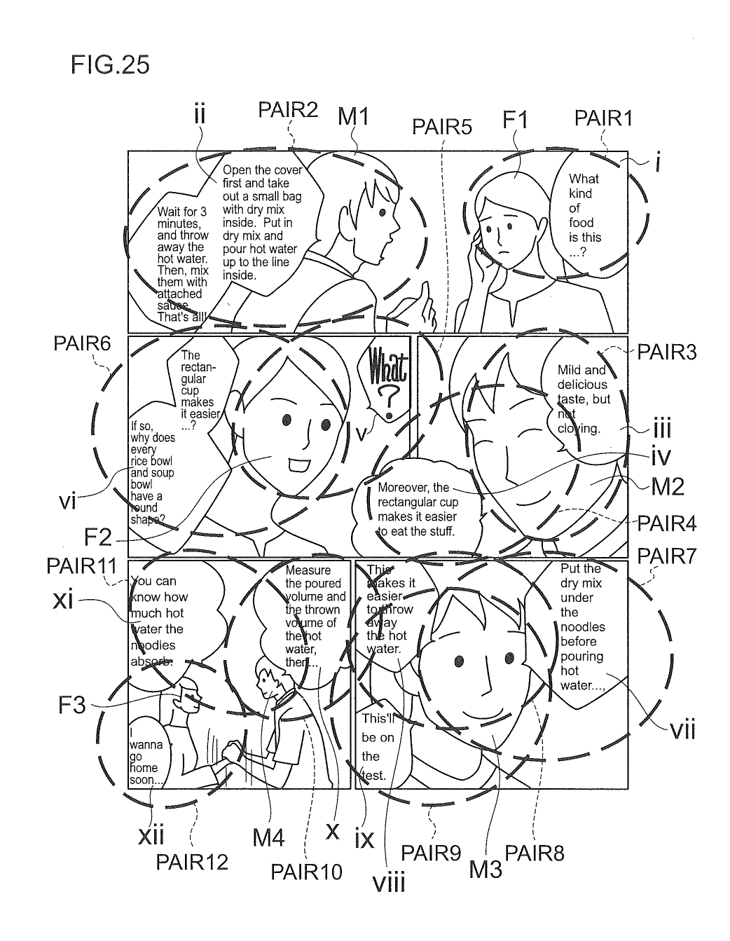

The authoring section 10 displays the content image in a state the association result is recognizable on the monitor 15 based on the modified information file. As a result, the modification result of the pair 11 can be checked on the monitor 15 as shown in FIG. 25.

The association information may be allotted with a number. The authoring section 10 may allot numbers from the association of the speech bubble located at the top right, or may allot numbers based on the input through the operation section 12. The numbers may represent the display order of the speech bubble.

Finally, the authoring section 10 stores a master data including the information file updated in steps S4-S9 and the content image in the DB 11 (step S10).

Note that it is also possible to employ a mode in which all the associations are manually performed. In this case, the authoring section 10 displays the content image on the monitor 15 in the state where the speech bubbles and ROIs which are set in steps S5 and S7 based on the information file can be selected. When the user selects the predetermined speech bubbles and ROIs one by one through the operation section 12, the authoring section 10 recognizes them and sets them as a pair. Since the woman F1 speaks in the speech bubble i, when the speech bubble i and the woman F1 are selected through the operation section 12, the authoring section 10 automatically recognizes the speech bubble i and the woman F1 as a pair and sets the speech bubble i and the woman F1 as a pair 1. Likewise, when the speech bubble ii and the man M1 are selected through the operation section 12, the authoring section 10 automatically recognizes the speech bubble ii and the man M1 as a pair and sets the speech bubble ii and the man M1 as pair 2. After completing the association on every speech bubble, the authoring section 10 stores the association result in the information file.

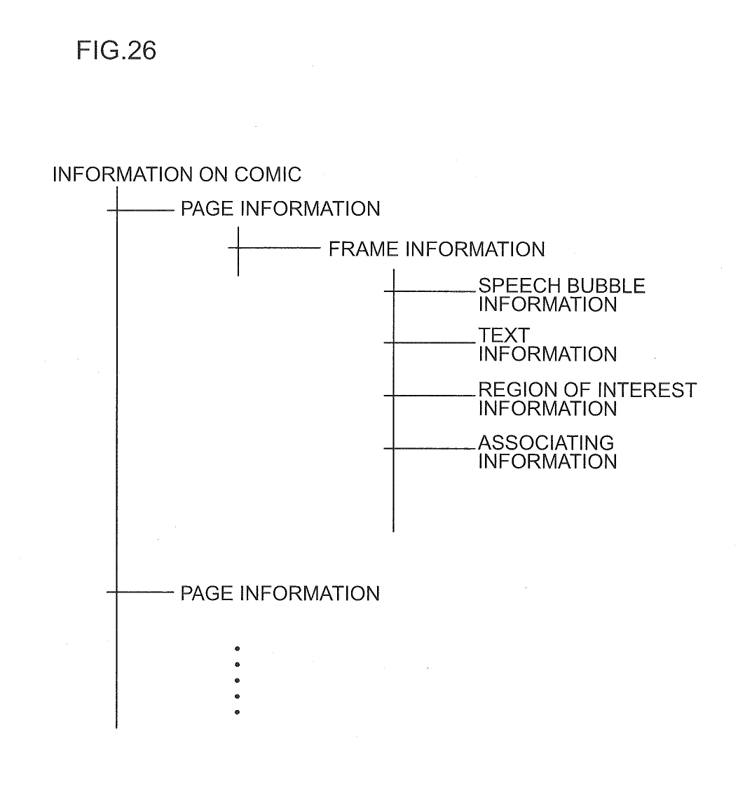

As the information file, a file of XML file format, for example, can be used. FIG. 26 illustrates a structure of the information file. In this embodiment, since each comic has an information file, the information file includes plural pieces of page information. The respective pages have page information; frame information is associated with the page information; and the speech bubble information, the text information, the region of interest information, and the association information are associated with the frame information.

As described above, as the association information, there is recorded information indicating that two or more pieces of information from among frame information including frame region information of each frame within a page, speech bubble information including speech bubble region information indicating a region within an image of a speech bubble, text region information indicating a region of text of a comic, and region of interest information (ROI) indicating a region of interest of the comic are associated with each other as pieces of associated information by the authoring section 10.

Note that the information file may be generated not for each comic but for each page.

The creation of the master data including the image file of the comic and the information file thereof makes it possible to edit the content in accordance with the digital book viewer, automatically translate the text, perform translation editing and sharing, and perform display processing appropriate for a digital book viewer, etc., which facilitate delivery of the digital book.

In this embodiment, the authoring section 10 acquires a content image and creates a master data which stores the frame information, the speech bubble information, the text information and the like. However, the authoring section 10 may acquire a master data (equivalent to the master data created in step S2 shown in FIG. 2) which has an information file storing various kinds of information, and then perform the processing in steps S3-S10 and may store a final master data in the DB. Also, the authoring section 10 may acquire a master data (equivalent to the master data created in step S3 shown in FIG. 2) which has an information file in which frames, speech bubbles and texts are automatically extracted, and the frame information, the speech bubble information and the text information are stored, and may store a final master data in the DB after performing the processing in steps S4-S10.

(B) Master Data Edition Processing

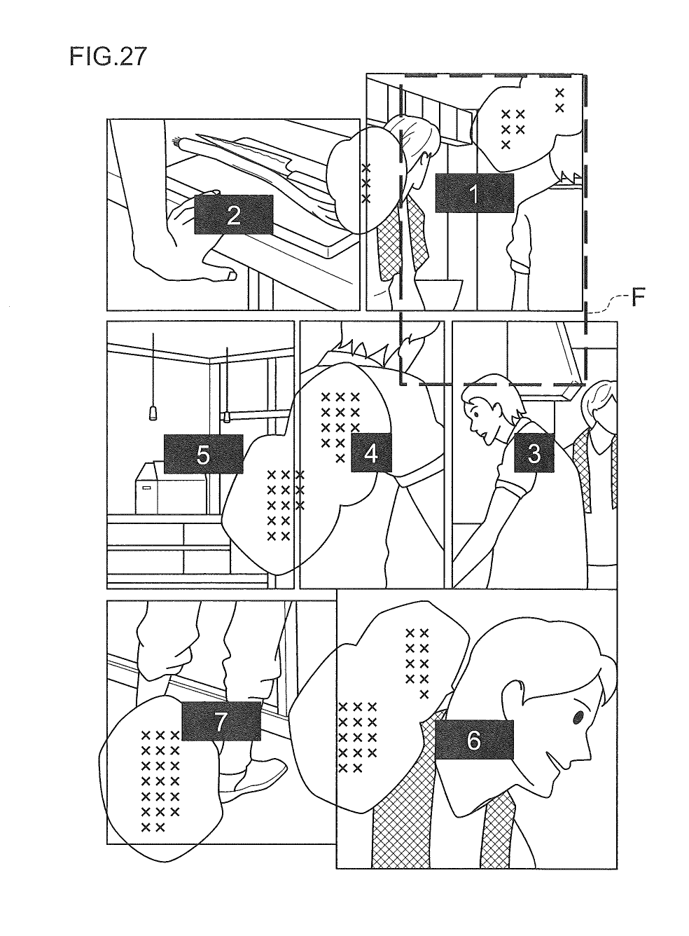

FIG. 27 illustrates a display screen for performing editing for a digital book viewer. The authoring section 10 displays a content image on the monitor 15. The authoring section 10 displays the frame boundary line of each frame with a thick line based on the information file. Roughly in the center of each frame, a frame order representing reading order of the frame is displayed. The display of the frame order is not limited to the above, but the frame order may be displayed at a corner of the frame.

The authoring section 10 acquires a screen size of the digital book viewer 2 from the DB 11 or the like, and displays a border F representing the screen size of the digital book viewer 2 superimposing the same on the content image based on the information on the screen size of the digital book viewer 2 and the information of the information file. When the user input an instruction to shift the frame F vertically/horizontally through the operation section 12, the authoring section 10 shifts the frame F vertically/horizontally responding to the instruction from the operation section 12.

The authoring section 10 determines the minimum display times; that is, scroll times necessary for displaying entire of the frame based on the information on the screen size of the digital book viewer 2 and the information of the information file and displays the information (marker) superimposing the same on the content image. In this embodiment, since the marker is displayed roughly in the center of each frame, in the FIG. 27, the frame order is displayed being superimposed on the marker.

In FIG. 27, scroll times are represented with a rectangular marker. When the scroll time is once, in FIG. 27, the frame order is displayed with a marker of square shape of a in each edge length like frames 3 and 4. When the scroll times are two or more, a rectangular marker of a of integer times in an edge length is displayed. When the scroll in a vertical direction is n times; and the scroll in the horizontal direction is m times, a rectangular marker of na×ma in vertical and horizontal length is displayed. In frames with frame order 1, 2, 6 and 7 in FIG. 27, since horizontal scroll is two times and vertical scroll is once, a rectangular marker of 2a in horizontal direction and a in vertical direction is displayed. By displaying the marker as described above, the times and direction of the scroll can be easily understood at a glance of the marker without interposing the frame F on each frame.

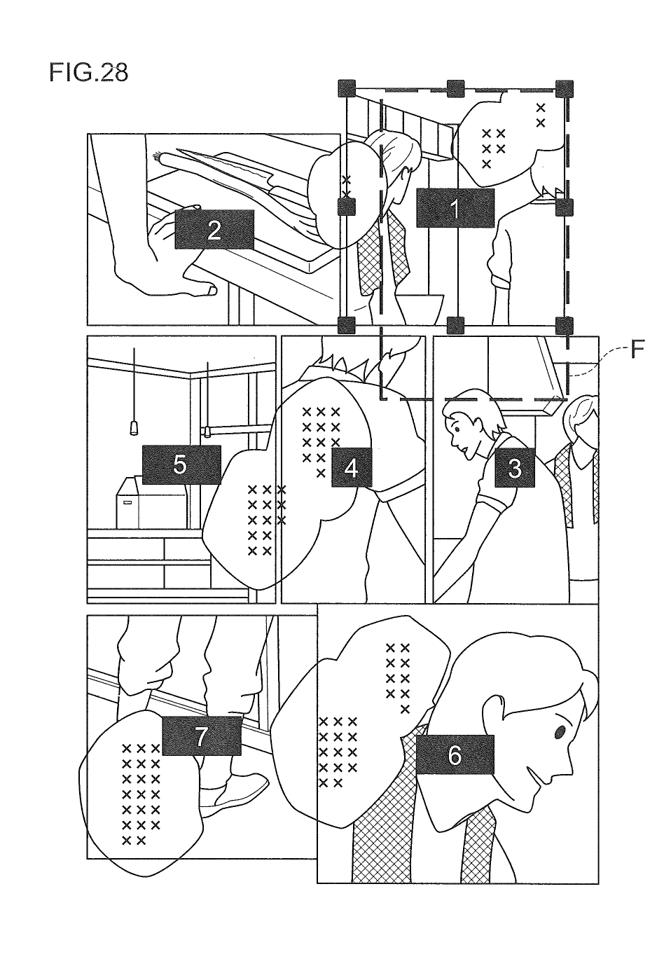

The user shifts the frame boundary line as described above while monitoring the image displayed on the monitor 15. When the user makes double click or the like on the frame boundary line through the operation section 12, the authoring section 10 displays vertexes on the frame boundary line as shown in FIG. 28 to allow editing on the frame boundary line. When the user drags a desired vertex through the operation section 12 same as step S4 (FIG. 9), the vertex is shifted and the shape of the frame boundary line is modified. By repeating this operation, shape (for example, change from a pentagon to a rectangle) and size of the frame boundary line can be changed. Also, a vertex may be added or deleted. Since the operation to add or delete a vertex is the same as step S4, the description thereof is omitted here.

When the size of a frame is slightly larger than the screen size of the digital book viewer 2, the authoring section 10 displays a frame boundary line of a frame slightly larger than the screen size of the digital book viewer 2 with a color different from that of the other frame boundary lines based on the information on the screen size of the digital book viewer 2 and the information of the information file. The case when the vertical and horizontal sizes of the frame is slightly larger than the screen size of the digital book viewer 2 is conceivable that, for example, assuming about 10% of the screen size of the digital book viewer 2 as the threshold value, a case where the length of a edge of the frame is larger by about 10% than the screen size of the digital book viewer 2. In FIG. 27, the frame boundary line of the frame with frame order 5 is indicated with a color different from that of other frame boundary lines.

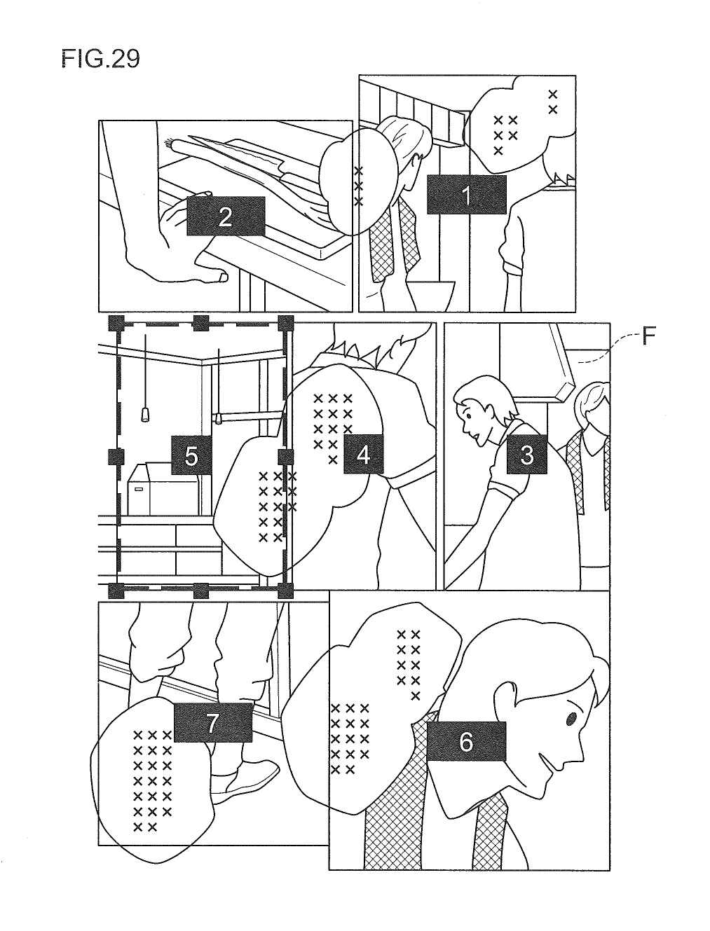

In the frame slightly larger than the screen size of the digital book viewer 2, the scroll time can be reduced to once and the visibility can be increased by arranging a portion with little importance within the frame to be invisible as if the same is not included in the frame. As shown in FIG. 29, the position and shape of the frame boundary line of the frame with frame order 5 which is slightly larger than the frame F are changed so that the scroll time becomes once. In FIG. 29, the frame with frame order 5 is arranged to be smaller so that a left end part is excluded from the frame resulting in scroll time of once.

After changing the scroll time as described above, the authoring section 10 detects the same and updates the information file. Also, the authoring section 10 changes the size of the marker to axa, and changes the color of the frame boundary line of the frame with frame order 5 to the same color of the other frames.

The frame boundary line may be deleted or added. Since the method to add/delete the frame boundary line is the same as the method in step S4, the description thereof is omitted. For example, in a state a predetermined frame is selected, when a predetermined frame boundary line of the frame is selected by the user through the operation section 12, the selected frame is deleted. For example, when the size of the frame is small and the frame F includes two frames, efficient display is possible by using a single frame.

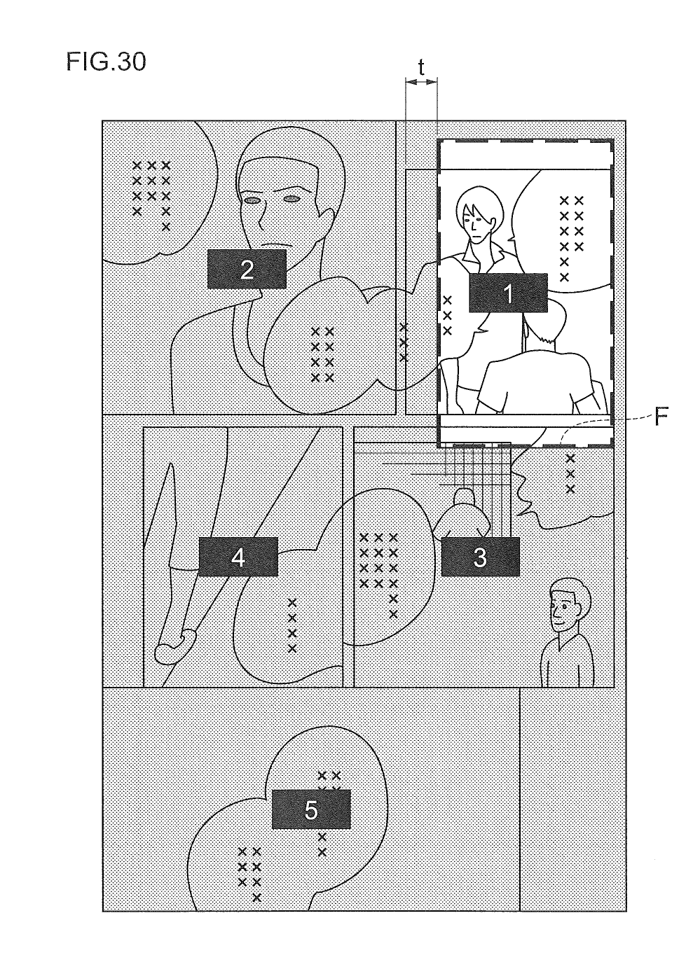

The authoring section 10 is capable of displaying a preview screen on the monitor 15. FIG. 30 illustrates an example of the preview screen. The authoring section 10 displays a content image on the monitor 15 while superimposing the border F representing the screen size of the digital book viewer 2 on the content image. The authoring section 10 translucently covers over the outside of the frame F to preview screen which is visible only the inside of the frame F. Not only translucently covering over the outside of the frame F, the outside of the frame F may be covered over with gray color.

When the user gives an instruction through the operation section 12, the authoring section 10 scrolls the frame F to display the next preview screen. When any frame is rest without being previewed, the authoring section 10 shifts the frame F to show every frame under being previewed to translucently display the outside of the frame F so that every frame can be previewed. In the example shown in FIG. 30, the frame F is shifted leftward by a distance of “t”.

When the preview is completed on every frame under being previewed, the authoring section 10 shift the frame F so that the right end of the frame with next frame order aligns with the right end of the frame F, and translucently displays the outside of the frame F.

With this, the user can check the state of the images on the digital book viewer 2. Accordingly, the master data can be edited more appropriately.

The edition processing of the master data is not limited to the case where the authoring section 10 creates the master data. A master data created by an external digital comic generating device may be stored in the DB 11 of the server 1 and edit the same.

[Details of Correction Processing for Association]

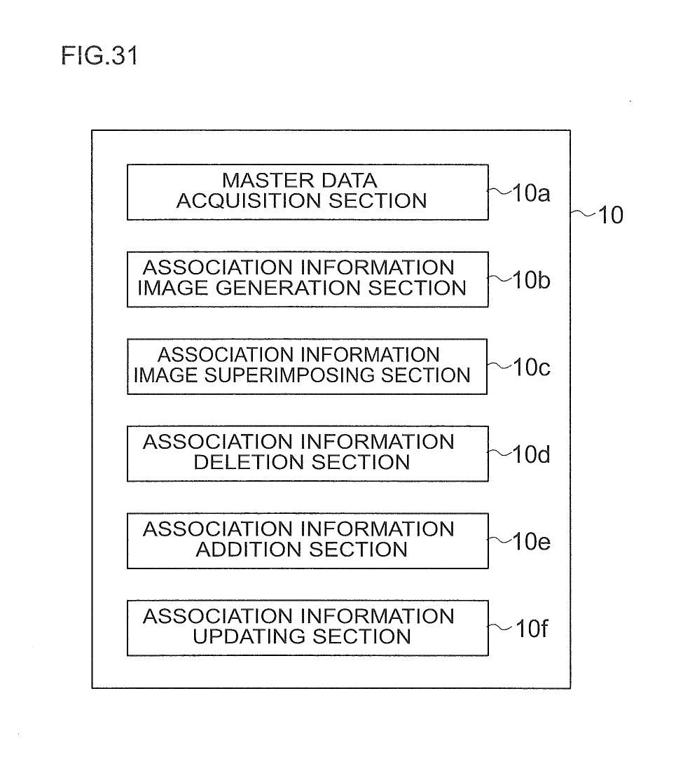

FIG. 31 is a block diagram illustrating an internal structure of the authoring section 10, and mainly illustrates functional blocks related to the association information. As illustrated in the figure, the authoring section 10 includes a master data acquisition section 10a, an association information image generation section 10b, an association information image superimposing section 10c, an association information deletion section 10d, an association information addition section 10e, and an association information updating section 10f, etc.

The master data acquisition section 10a functions as a master data acquisition unit that acquires master data obtained by connecting a content image with an information file from the DB 11, and stores the acquired data in a RAM (not illustrated).

The association information image generation section 10b functions as an image generation unit that reads out the association information included in the information file within the master data stored in the RAM, and generates an image indicating regions associated with each other. The association information image superimposing section 10c functions as a display control unit that superimposes a page image of the image file within the master data stored in the RAM with the image generated by the association information image generation section 10b, and displays them on the monitor 15 in accordance with the operation of the operation section 12 by the user.

The association information deletion section 10d functions as an association information deletion unit that deletes association information of the information file within the master data stored in the RAM in accordance with the operation of the operation section 12 by the user. Likewise, the association information addition section 10e functions as an association information addition unit that adds association information of the information file within the master data stored in the RAM in accordance with the operation of the operation section 12 by the user.

The association information updating section 10f functions as an editing unit that updates the master data within the DB 11 based on the information file within the RAM in which the association information is deleted or added by the association information deletion section 10d or the association information addition section 10e.

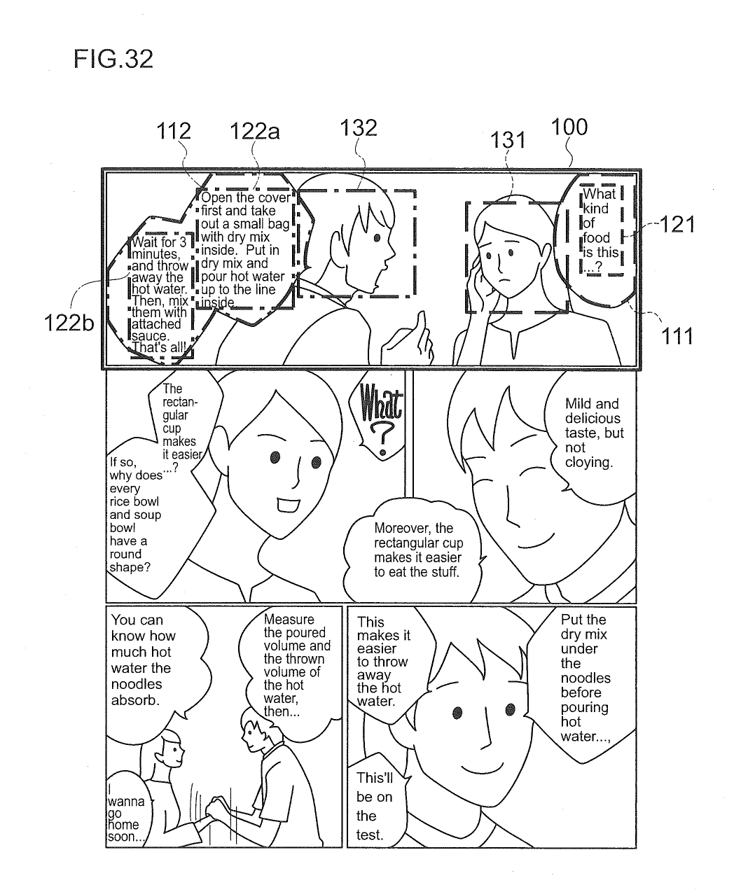

FIG. 32 is a diagram illustrating the association information display performed based on the association information stored in the information file, and illustrates a mode different from that of FIG. 24. As illustrated in the figure, an image obtained by depicting the outer peripheral edge of each of a speech bubble region, a text region, and an ROI region, which are associated with each frame, so as to correspond to the selected frame is superimposingly displayed on the image on the monitor 15.

The example of FIG. 32 illustrates a case where a frame 100 is selected by the operation section 12. The master data acquisition section 10a acquires the master data of the page from the DB 11 and stores the data in the RAM. Further, the master data acquisition section acquires the association information of the selected frame 100 from the information file of the master data stored in the RAM. Assume herein that speech bubbles 111 and 112, text regions 121, 122a, and 122b, and ROIs 131 and 132 are associated with the frame 100. Further, the speech bubble 111, the text region 121, and the ROI 131 are associated with each other as one group (group a), and the speech bubble 112, the text regions 122a and 122b, and the ROI 132 are associated with each other as one group (group b).

The association information image generation section 10b generates an image obtained by depicting the outer peripheral edge of each of the speech bubbles 111 and 112, the text regions 121, 122a, and 122b, and the ROIs 131 and 132 which are associated with the frame 100. At this time, in the group a and the group b, in which different associations are set, images are generated with different line types. In the example of FIG. 31, an image is generated by depicting the outer peripheral edge by a broken line in the group a, and an image is generated by depicting the outer peripheral edge by an alternate long and short dash line in the group b.

The association information image superimposing section 10c displays, in a superimposed manner, the generated image and the image data within the master data stored in the RAM on the monitor 15. The display in a superimposed manner enables the user to recognize the speech bubble region, the text region, and the ROI which are associated with the selected frame. When a plurality of different associations are set in the selected frame, such a display as to distinguish each of the associations enables the user to recognize how the associations are set.

Note that the color may be changed instead of changing the line type of the line depicting the outer peripheral edge. A portion other than the selected frame 100 of the displayed image (page) may be displayed with a contrast lowered to clarify that the portion is not selected, for example. Furthermore, a plurality of frames may be configured so as to be selected, and association information may be displayed simultaneously for all frames.

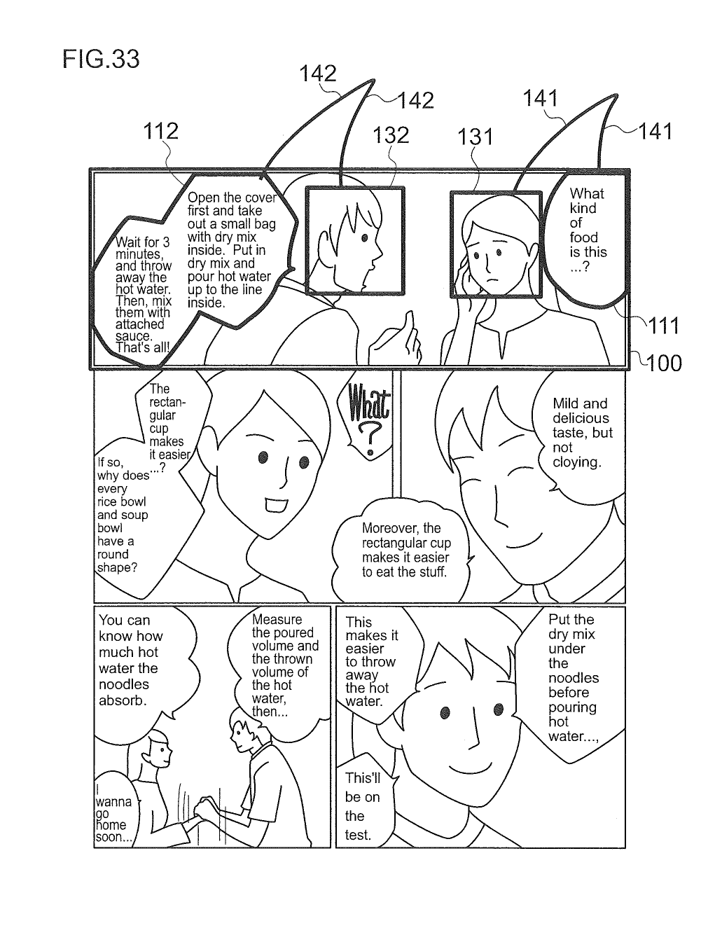

The association information may be displayed as illustrated in FIG. 33. Specifically, an image obtained by depicting a line connecting each of the speech bubble region, the text region, and the ROI, which are associated with a selected frame, so as to correspond to the selected frame, may be superimposed on the image.

In the example of FIG. 33, when the frame 100 is selected by the operation section 12, lines 141 and 142 are depicted from the speech bubbles 111 and 112 and ROIs 131 and 132 which are associated with the frame 100. The speech bubble 111 and the ROI 131, which are associated with each other, are connected by the line 141, and the speech bubble 112 and the ROI 132, which are associated with each other, are connected by the line 142.

Though the text region is herein omitted, when the text region is included in the association with the frame 100, images to be connected by a line may be generated, superimposed and displayed in a similar manner. The line type and color may be changed between the lines 141 and 142.

Even in the display as illustrated in FIG. 33, the user can recognize the speech bubble region, the text region, and the ROI which are associated with the selected frame. When a plurality of different associations are set in the selected frame, such a display as to distinguish each of the associations enables the user to recognize how the associations are set.

Next, details of the correction processing for association will be described. Assume herein that in the information file of the master data, speech bubbles 160a, 160b, and 160c are associated with a frame 150 and the speech bubble 162 is associated with a frame 152.

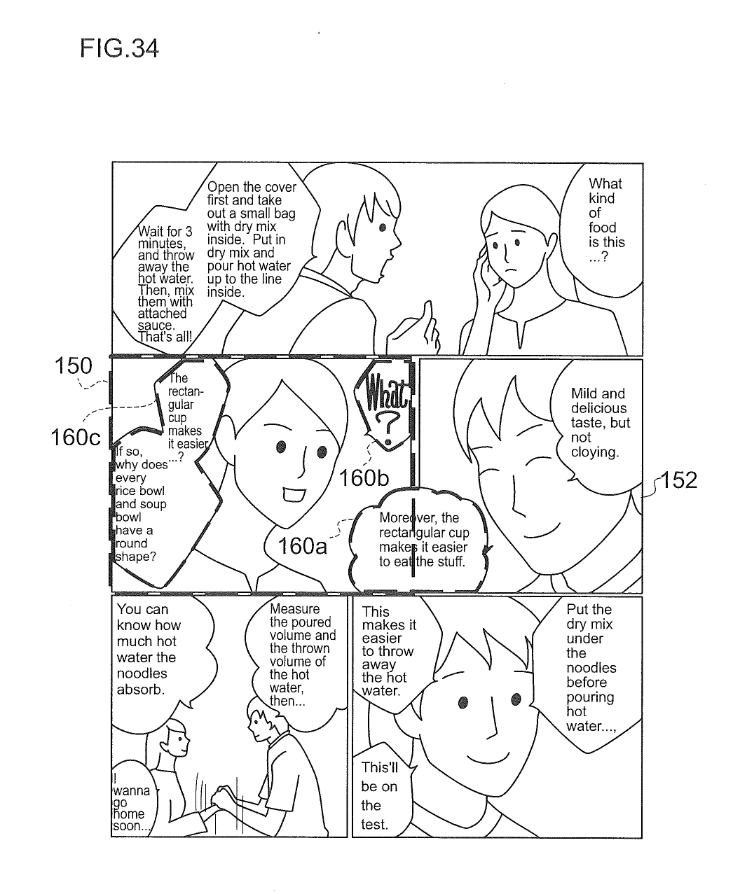

When the frame 150 is selected by the operation section 12, the association information image generation section 10b generates an image obtained by depicting the outer peripheral edge of each area of the frame 150 and the speech bubbles 160a, 160b, and 160c based on the master data acquired from the DB 11 by the master data acquisition section 10a. The association information image superimposing section 10c superimposes the image with the page image and displays the image on the monitor 15. FIG. 34 illustrates the image displayed on the monitor 15.

In the automatic association setting of the authoring section 10, the speech bubble 160a is associated with the frame 150. In the automatic association setting, speech bubbles and ROIs which exist in each of a plurality of frames are determined by comparing the areas of the speech bubbles and ROIs that occupy the largest area of each frame, for example, like in the speech bubble 160a. Assume herein that the speech bubble 160a is associated with the frame 150 because the area existing in the frame 150 is larger than the area existing in the frame 152. However, in practice, the speech bubble 160a should be associated with the frame 152. Here, a description is given of an example in which the speech bubble 160a is corrected (updated) so as to be associated with the frame 152.

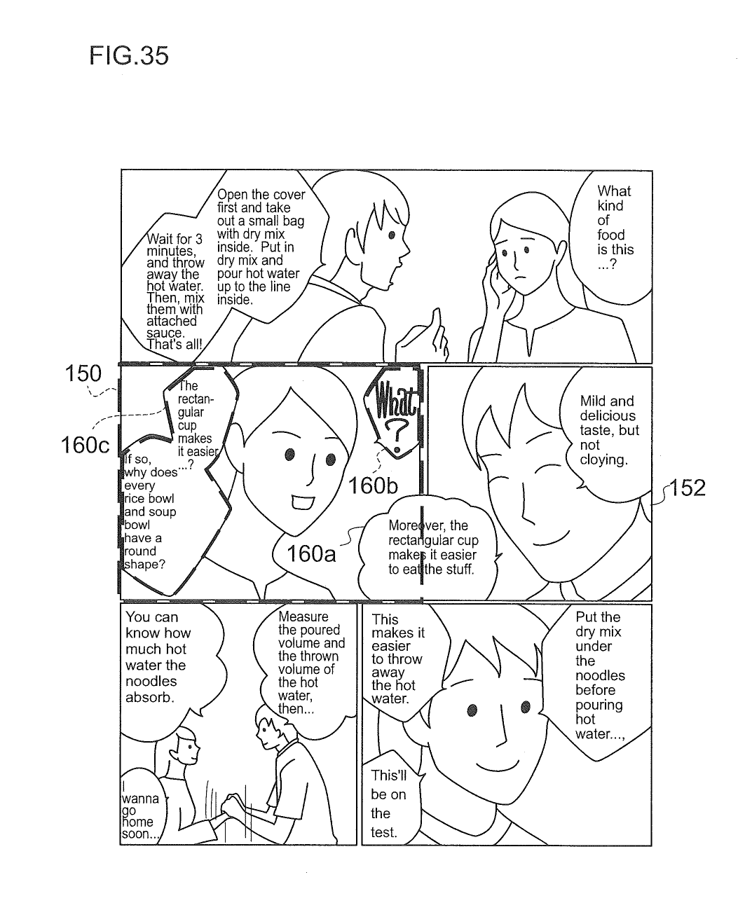

First, the user selects an association information correction icon (not illustrated) by the operation section 12 in the state where the image illustrated in FIG. 34 is displayed on the monitor 15, and selects the speech bubble 160a. In accordance with this operation, the association information image generation section 10b generates an image in which the outer peripheral edge of the region of the speech bubble 160a is not depicted and the outer peripheral edge of each region of the frame 150 and the speech bubbles 160b and 160c is depicted. The association information image superimposing section 10c superimposes this image on the image of the page and displays the image on the monitor 15. FIG. 35 illustrates the image displayed on the monitor 15 at this time.

After the correction is completed in this state, the association information deletion section 10d deletes the speech bubble 160a from the association information of the frame 150 within the information file of the master data stored in the RAM. The association information updating section 10f updates the master data of the DB 11 based on the master data stored in the RAM. As a result, the frame 150 and the speech bubble 160a are not associated with each other.

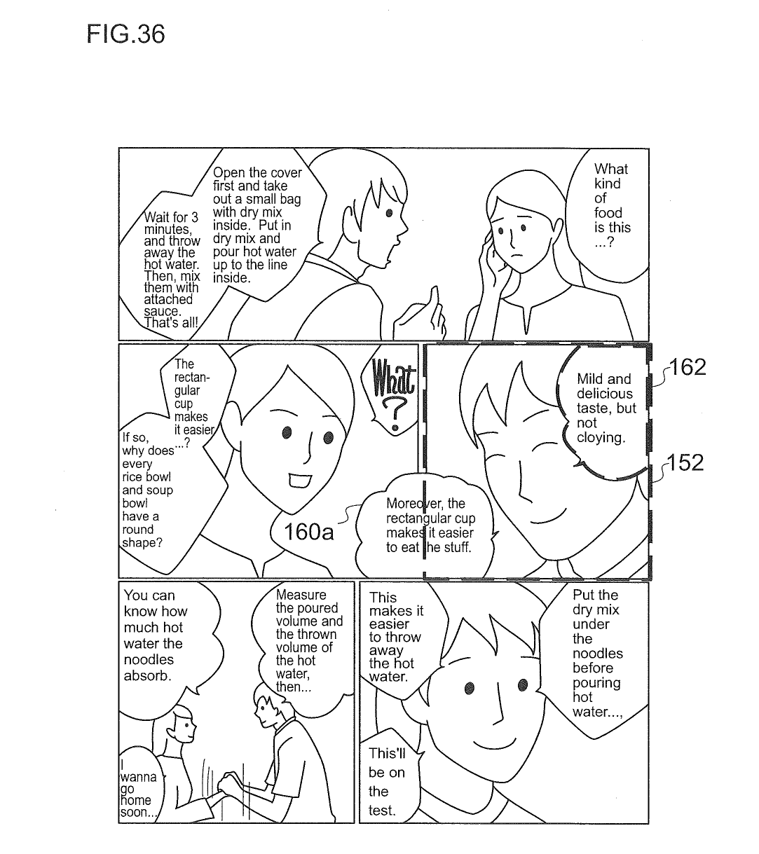

Next, when the frame 152 is selected by the operation section 12, the association information image generation section 10b generates an image obtained by depicting the outer peripheral edge of the regions of the frame 152 and the speech bubble 162 associated with the frame 152 in accordance with the operation. The association information image superimposing section 10c superimposes this image on the image of the page and displays the image on the monitor 15. FIG. 36 illustrates the image displayed on the monitor 15 at this time.

In this state, the association information correction icon (not illustrated) is selected again, and the speech bubble 160a is selected. In accordance with this operation, the association information image generation section 10b generates an image obtained by depicting the outer peripheral edge of each of the regions of the speech bubble 162 associated with the frame 152 and the selected speech bubble 160a. The association information image superimposing section 10c superimposes this image on the image of the page and displays the image on the monitor 15.

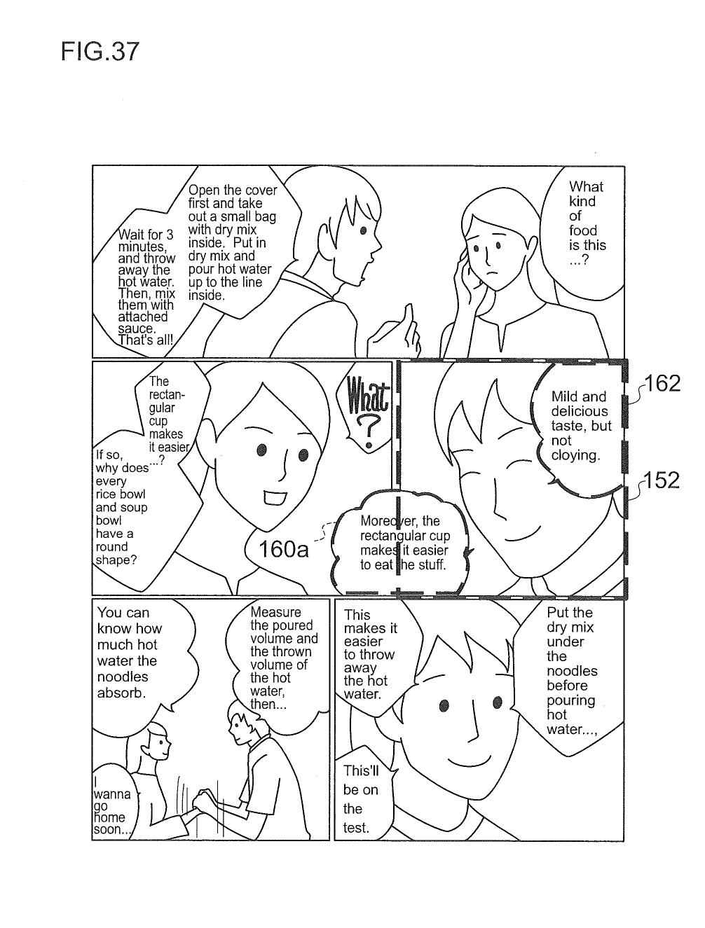

As a result, as illustrated in FIG. 37, the image obtained by depicting the outer peripheral edge of each of the regions of the frame 152 and the speech bubbles 162 and 160a is superimposed and displayed.

When the correction is completed in this state, the association information addition section 10e adds the speech bubble 160a to the association information of the frame 152 within the information file of the master data stored in the RAM. The association information updating section 10f updates the master data of the DB 11 based on the master data stored in the RAM. As a result, the frame 152 and the speech bubble 160a are associated with each other.

The structure as described above enables the user to manually update the association information.

Note that when there is a plurality of ROIs in the frame in the case of newly adding a speech bubble or text to the association information of the frame, it may be unclear which ROI is associated with the added speech bubble or text. In this case, the user may select an ROI to be associated.

According to the embodiment, master data of the content of a digital comic is created and edited by the delivery server of a digital book. However, as for the apparatus for creating the master data may be a digital comic editor different from the server which delivers the content. The digital comic editor may be configured with a general purpose personal computer in which a digital comic editing program according to the invention is installed via a non-transitory computer readable storing medium storing the same.

The master data which is created and edited as described above is delivered through a server (delivery server) responding to a delivery request from various mobile terminals. In this case, the delivery server acquires information on the model of the mobile terminal. The master data may be delivered after being processed into the data suitable for browsing by the model (screen size etc.); the master data may be delivered without being processed. When the master data is delivered without being processed, the master data has to be converted into the data suitable for the mobile terminal using viewer software at the mobile terminal side before the master data can be browsed. However, the master data includes an information file as described above. The viewer software uses the information described in the information file to display the content on the mobile terminal.

Further, the technical scope of the present invention is not limited to the scope of the above embodiments. The components in each embodiment can be combined as appropriate between the embodiments without departing from the gist of the present invention.

What is claimed is:

1. A digital comic editor, comprising:
a data acquisition unit that acquires master data of a digital comic including an image file corresponding to each page of the comic, the image file having a high resolution image of the entire page; and an information file corresponding to each page or all pages of the comic, the information file having described therein two or more pieces of information from among: frame information including frame region information of each frame within the page; speech bubble information including speech bubble region information indicating a region within the image of a speech bubble including a line of a character of the comic; text region information indicating a text region of the comic; and region of interest information indicating a region of interest of the comic, and association information for associating the two or more pieces of information;
a display control unit that causes a display unit to display an image thereon based on the image file in the master data acquired by the data acquisition unit, to superimposingly display an image indicating each piece of region information included in the two or more pieces of information on the image based on the two or more pieces of information, and to superimposingly display an image indicating that the two or more pieces of information are associated with each other on the image based on the association information;
an indication unit that indicates a position on the image displayed on the display unit;
an association information addition unit that adds association information for associating a plurality of pieces of region information corresponding to the position indicated by the indication unit;
an association information deletion unit that deletes the association of the plurality of pieces of region information corresponding to the position indicated by the indication unit; and
an editing unit that updates the association information included in the information file based on the association information added by the association information addition unit and the association information deleted by the association information deletion unit.

2. The digital comic editor according to claim 1, wherein the display control unit superimposingly displays an image obtained by depicting an outer peripheral edge of each of the regions corresponding to the two or more pieces of information associated with each other based on the association information, by using the same color or line type, on the image.

3. The digital comic editor according to claim 1, wherein the display control unit superimposingly displays an image obtained by depicting a lead line connecting the regions corresponding to the two or more pieces of information associated with each other based on the association information, on the image.

4. The digital comic editor according to claim 1, wherein
the region of interest information is region information including a character within the comic, and
the association information is information for associating region of interest information including the character, speech bubble region information indicating a speech bubble region including a line of the character, or text region information indicating a text region within the speech bubble region.

5. The digital comic editor according to claim 1, wherein the association information is information for associating the frame information, the speech bubble information, text region information, and region of interest information.

6. The digital comic editor according to claim 1, wherein the frame region information of each frame is coordinate data representing each vertex on a polygonal frame boundary enclosing each frame, vector data representing the frame boundary, or mask data representing a frame region of each frame.

7. The digital comic editor according to claim 1, wherein the speech bubble region information is coordinate data representing a plurality of points corresponding to a shape of the speech bubble, vector data representing the shape of the speech bubble, or mask data representing a region of the speech bubble.

8. The digital comic editor according to claim 1, wherein the text region information is coordinate data representing each vertex on a polygonal outer peripheral edge of the text region, vector data representing the outer peripheral edge of the text region, or mask data representing the text region.

9. The digital comic editor according to claim 1, wherein the region of interest information is coordinate data representing each vertex on a polygonal outer peripheral edge of the region of interest, vector data representing the outer peripheral edge of the region of interest, or mask data representing the region.

10. The digital comic editor according to claim 1, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

11. The digital comic editor according to claim 2, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

12. The digital comic editor according to claim 3, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

13. The digital comic editor according to claim 4, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

14. The digital comic editor according to claim 5, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

15. The digital comic editor according to claim 6, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

16. The digital comic editor according to claim 7, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

17. The digital comic editor according to claim 8, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

18. The digital comic editor according to claim 9, further comprising:
an image acquisition unit that acquires an image file having a high resolution image of the entire page;
a region extraction unit that analyzes the image of the entire page acquired by the image acquisition unit and automatically extracts two or more regions from among a frame region of each frame within the page, a speech bubble region, a text region and a region of interest;
information file creation unit that creates the information file having described therein information indicating the two or more regions extracted by the frame region extraction unit, and association information of the two or more regions; and
a master data creation unit that creates the master data of the digital comic including the image file of each page of the comic acquired by the image acquisition unit and the information file corresponding to each page or all pages of the comic created by the information file creation unit,
wherein the data acquisition unit acquires the master data created by the master data creation unit.

19. A digital comic editing method, comprising:
a data acquisition step acquiring master data of a digital comic including an image file corresponding to each page of the comic, the image file having a high resolution image of the entire page; and an information file corresponding to each page or all pages of the comic, the information file having described therein two or more pieces of information from among: frame information including frame region information of each frame within the page; speech bubble information including speech bubble region information indicating a region within the image of a speech bubble including a line of a character of the comic; text region information indicating a text region of the comic; and region of interest information indicating a region of interest of the comic, and association information for associating the two or more pieces of information;
a display control step causing a display unit to display an image thereon based on the image file in the master data acquired by the data acquisition step, to superimposingly display an image indicating each piece of region information included in the two or more pieces of information on the image based on the two or more pieces of information, and to superimposingly display an image indicating that the two or more pieces of information are associated with each other on the image based on the association information;
an indication step indicating a position on the image displayed on the display unit;
an association information addition step adding association information for associating a plurality of pieces of region information corresponding to the position indicated by the indication step;
an association information deletion step deleting the association of the plurality of pieces of region information corresponding to the position indicated by the indication step; and
an editing step updating the association information included in the information file based on the association information added by the association information addition step and the association information deleted by the association information deletion step.

20. A non-transitory computer-readable medium storing a digital comic editing program causing a computer to achieve:
a data acquisition function to acquire master data of a digital comic including an image file corresponding to each page of the comic, the image file having a high resolution image of the entire page; and an information file corresponding to each page or all pages of the comic, the information file having described therein two or more pieces of information from among: frame information including frame region information of each frame within the page; speech bubble information including speech bubble region information indicating a region within the image of a speech bubble including a line of a character of the comic; text region information indicating a text region of the comic; and region of interest information indicating a region of interest of the comic, and association information for associating the two or more pieces of information;
a display control function to cause a display unit to display an image thereon based on the image file in the master data acquired by the data acquisition function, to superimposingly display an image indicating each piece of region information included in the two or more pieces of information on the image based on the two or more pieces of information, and to superimposingly display an image indicating that the two or more pieces of information are associated with each other on the image based on the association information;
an indication function to indicate a position on the image displayed on the display unit;
an association information addition function to add association information for associating a plurality of pieces of region information corresponding to the position indicated by the indication function;
an association information deletion function to delete the association of the plurality of pieces of region information corresponding to the position indicated by the indication function; and
an editing function to update the association information included in the information file based on the association information added by the association information addition function and the association information deleted by the association information deletion function.
